(19) United States
(12) Patent Application Publication
(10) Pub. No.: US 2007/0138978 A1
(43) Pub. Date: Jun. 21, 2007

(54) Conversion of solid state source output to virtual source

(75) Inventors: Jack C. Rains JR., Herndon, VA (US); Don F. May, Vienna, VA (US); David P. Ramer, Reston, VA (US)

Correspondence Address: MCDERMOTT WILL & EMERY LLP, 600 13TH STREET, N.W., WASHINGTON, DC, 20005-3096, US

(73) Assignee: ADVANCED OPTICAL TECHNOLOGIES, LLC

(21) Appl. No.: 11/591,458

(22) Filed: Nov. 2, 2006

Related U.S. Application Data
(63) Continuation-in-part of application No. 11/294,564, filed on Dec. 6, 2005, now Pat. No. 7,148,470.
Application No. 11/294,564 is a continuation of application No. 10/832,464, filed on Apr. 27, 2004, now Pat. No. 6,995,355.
Application No. 10/832,464 is a continuation-in-part of application No. 10/601,101, filed on Jun. 23, 2003, now Pat. No. 7,145,125.

(51) Int. Cl. H05B 41/36

(52) U.S. Cl. 315/291

(57) ABSTRACT

A light fixture converts source light from one or more solid state light emitting elements to a virtual light source output. An optical element receives and diffuses light from the solid state emitters to form a processed light for the virtual source output. The optical element forms light that is relatively uniform, for example having a substantially Lambertian distribution and/or having a maximum-to-minimum intensity ratio of 2 to 1 or less over the optical area of the virtual source. In the examples, the diffuse optical processing element comprises a cavity having at least one diffusely reflective surface, and the emitting elements supply light into the cavity at locations that result in reflection and diffusion before emission through an aperture of the cavity. The aperture or a downstream processing element appears as the virtual source of the processed light from the cavity.

### CROSS-REFERENCE TO RELATED APPLICATION

This application is a continuation-in-part of U.S. patent application Ser. No. 11/294,564 filed on Dec. 6, 2005, which is a continuation of U.S. patent application Ser. No. 10/832,464, filed Apr. 27, 2004 now U.S. Pat. No. 6,995,355, which is a continuation-in-part of U.S. patent application Ser. No. 10/601,101, filed Jun. 23, 2003, the disclosures of which are entirely incorporated herein by reference; and this application claims the benefits of the filing dates of those earlier applications.

### TECHNICAL FIELD

The present subject matter relates to techniques and equipment to provide lighting, particularly in a manner to convert light from one or more solid state light emitting elements into a virtual source, e.g., exhibiting highly uniform output emissions and/or light emissions of a desired spectral characteristic.

### BACKGROUND

An increasing variety of lighting applications require a precisely controlled spectral characteristic of the radiant electromagnetic energy. It has long been known that combining the light of one color with the light of another color creates a third color. For example, the commonly used primary colors Red, Green and Blue of different amounts can be combined to produce almost any color in the visible spectrum. Adjustment of the amount of each primary color enables adjustment of the spectral properties of the combined light stream. Recent developments for selectable color systems have utilized solid state devices, such as light emitting diodes, as the sources of the different light colors.

Light emitting diodes (LEDs) were originally developed to provide visible indicators and information displays. For such luminance applications, the LEDs emitted relatively low power. However, in recent years, improved LEDs have become available that produce relatively high intensities of output light. These higher power LEDs, for example, have been used in arrays for traffic lights. Today, LEDs are available in almost any color in the color spectrum. Other forms of solid state light emitting elements suitable for lighting applications are becoming commercially available.

Systems are known which combine controlled amounts of projected light from at least two LEDs of different primary colors. Attention is directed, for example, to U.S. Pat. Nos. 6,459,919, 6,166,496 and 6,150,774. Typically, such systems have relied on using pulse-width modulation or other modulation of the LED driver signals to adjust the intensity of each LED color output. The modulation requires complex circuitry to implement. Also, such prior systems have relied on direct radiation or illumination from the individual source LEDs.

In some applications, the LEDs may represent undesirably bright sources if viewed directly. Solid state light emitting elements have small emission output areas and typically they appear as small point sources of light. As the output power of solid state light emitting elements increases, the intensity provided over such a small output area represents a potentially hazardous light source. Increasingly, direct observation of such sources, particularly for any substantial period of time, may cause eye injury.

Also, the direct illumination from LEDs providing multiple colors of light has not provided optimum combination throughout the field of illumination. Pixelation often is a problem with prior solid state lighting devices. In some systems, the observer can see the separate red, green and blue lights from the LEDs at short distances from the fixture, even if the LEDs are covered by a translucent diffuser. The light output from individual LEDs or the like appear as identifiable/individual point sources or ‘pixels.’ Integration of colors by the eye becomes effective only at longer distances, otherwise the fixture output exhibits striations of different colors.

Another problem arises from long-term use of LED type light sources. As the LEDs age, the output intensity for a given input level of the LED drive current decreases. As a result, it may be necessary to increase power to an LED to maintain a desired output level. This increases power consumption. In some cases, the circuitry may not be able to provide enough light to maintain the desired light output level. As performance of the LEDs of different colors declines differently with age (e.g. due to differences in usage), it may be difficult to maintain desired relative output levels and therefore difficult to maintain the desired spectral characteristics of the combined output. The output levels of LEDs also vary with actual temperature (thermal) that may be caused by difference in ambient conditions or different operational heating and/or cooling of different LEDs. Temperature induced changes in performance cause changes in the spectrum of light output.

U.S. Pat. No. 5,803,592 suggests a light source design intended to produce a high uniformity substantially Lambertian output. The disclosed light design used a diffusely reflective hemispherical first reflector and a diffuser. The light did not use a solid state type light emitting element. The light source was an arc lamp, metal halide lamp or filament lamp. The light included a second reflector in close proximity to the lamp (well within the volume enclosed by the hemispherical first reflector and the diffuser) to block direct illumination of and through the diffuser by the light emitting element, that is to say, so as to reduce the apparent surface brightness of the center of the light output that would otherwise result from direct output from the source.

U.S. Pat. No. 6,007,225 to Ramer et al. (Assigned to Advanced Optical Technologies, L.L.C.) discloses a directed lighting system utilizing a conical light deflector. At least a portion of the interior surface of the conical deflector has a specular reflectivity. In several disclosed embodiments, the source is coupled to an optical integrating cavity; and an outlet aperture is coupled to the narrow end of the conical light deflector. This patented lighting system provides relatively uniform light intensity and efficient distribution of light over a field of illumination defined by the angle and distal edge of the deflector. However, this patent does not discuss particular color combinations or effects or address specific issues related to lighting using one or more solid state light emitting elements.

Hence, a need still exists for a technique to efficiently process electromagnetic energy from one or more solid state light emitting sources and direct uniform electromagnetic energy effectively toward a desired field of illumination, in a manner that addresses as many of the above discussed issues as practical.

### SUMMARY

Techniques, light fixtures and lighting systems disclosed herein convert point source light, from one or more solid state light emitters, to a virtual source of light.

For example, a disclosed light fixture, using one or more solid state light emitting elements, provides a virtual light source output. The output forms a virtual source in that the fixture output appears to be the source of illumination, as perceived from an area illuminated by the fixture. The solid state light emitting element(s) or point source(s) thereof are not individually perceptible from the illuminated area. An optical element processes light from the solid state emitter(s) to form light for output via a virtual source output area.

The optical processing element typically forms light that is relatively uniform, for example having a substantially Lambertian distribution and/or having a maximum-to-minimum intensity ratio of 2 to 1 or less over across the optical area of the virtual source. Where sources within the system emit light of a number of different colors, the virtual source appears to be a uniform source of light of a color obtained by the combination of the various colors of lights from the sources.

In the examples, the mixing element comprises a cavity having at least one diffusely reflective surface, and the emitting element(s) supply light into the cavity at locations not visible through an aperture of the cavity that forms the optical output area. Hence, light from the emitting element(s) is diffusely reflected one or more times within the cavity before emission in the light output through the aperture. The aperture or a downstream light processing element appears as the virtual source of the uniform light output.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations of virtual source solid state lighting in accord with the present concepts, by way of example only, not by way of limitations. In the figures, like reference numerals refer to the same or similar elements.

FIG. 1A illustrates an example of light emitting system including a fixture using a solid state light emitting element, with certain elements of the fixture shown in cross-section.

FIG. 1B illustrates another example of a light emitting system using a plurality of solid state light emitting elements and a feedback sensor, with certain elements of the fixture shown in cross-section.

FIG. 1C illustrates another example of a light emitting system using white light type solid state light emitting elements of different color temperatures, with certain elements of the fixture shown in cross-section.

FIG. 1D illustrates another example of a light emitting system, using white type solid state light emitting elements of substantially the same color temperature, with certain elements of the fixture shown in cross-section.

FIG. 1E illustrates an example of a light emitting system in which one of the solid state light emitting elements emits ultraviolet (UV) light.

FIG. 1F illustrates an example of a light emitting system in which one of the solid state light emitting elements emits infrared (IR) light.

FIG. 2 illustrates an example of a radiant energy emitting system using primary color LEDs as solid state light emitting elements using primary color LEDs, with certain fixture elements shown in cross-section.

FIG. 3 illustrates another example of a light emitting system, with certain elements thereof shown in cross-section.

FIG. 4 is a bottom view of the fixture in the system of FIG. 3.

FIG. 5 illustrates another example of a light emitting system, using fiber optic links from the LEDs to the optical integrating cavity.

FIG. 6 illustrates another example of a light emitting system, utilizing principles of mask and cavity type constructive occlusion.

FIG. 7 is a bottom view of the fixture in the system of FIG. 6.

FIG. 8 illustrates an alternate example of a light emitting system, utilizing principles of constructive occlusion.

FIG. 9 is a top plan view of the fixture in the system of FIG. 8.

FIG. 10 is a functional block diagram of the electrical components, of one of the systems, using programmable digital control logic.

FIG. 11 is a circuit diagram showing the electrical components, of one of the systems, using analog control circuitry.

FIG. 12 is a diagram, illustrating a number of radiant energy emitting systems with common control from a master control unit.

FIG. 13 is a layout diagram, useful in explaining an arrangement of a number of the fixtures of the system of FIG. 12.

FIG. 14 depicts the emission openings of a number of the fixtures, arranged in a two-dimensional array.

FIGS. 15A to 15C are cross-sectional views of additional examples, of optical cavity LED light fixtures, with several alternative elements for processing of the combined light emerging from the cavity.

FIG. 16 is a cross-sectional view of another example of an optical cavity LED light fixture, using a collimator, iris and adjustable focusing system to process the combined light output.

FIG. 17 is a cross-sectional view of another example of an optical cavity LED light fixture.

FIG. 18 is an isometric view of an extruded section of a fixture having the cross-section of FIG. 17.

FIG. 19 is a front view of a fixture for use in a luminance application, for example to represent the letter “I.”

FIG. 20 is a front view of a fixture for use in a luminance application, representing the letter “L.”

FIG. 21 is a cross-sectional view of another example of an optical cavity LED light fixture, as might be used for a “wall-washer” application.

FIG. 22 is an isometric view of an extruded section of a fixture having the cross-section of FIG. 21.

FIG. 23 is a cross-sectional view of another example of an optical cavity LED light fixture, as might be used for a “wall-washer” application, using a combination of a white light source and a plurality of primary color solid state light sources.

FIG. 24 is a cross-sectional view of another example of an optical cavity LED light fixture, in this case using a deflector and a combination of a white light source and a plurality of primary color solid state light sources.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present concepts. Reference now is made in detail to the examples illustrated in the accompanying drawings and discussed below.

The techniques disclosed herein convert one or more solid state light sources of relatively small areas (“point sources”) into a virtual source of a larger area. Although other technologies for diffuse processing of light may be used to form the virtual source output, the examples use optical cavity processing. The light output forms a virtual output in that the fixture or system output, e.g., at an aperture of the cavity or an output of a further optical processing element, forms the apparent source of light as perceived from the area that is being illuminated. Point source light generated by one or more solid state light emitters, is not individually perceived as the source(s) of light from the perspective of the illuminated area. Instead, the virtual source appears as the single source of uniform light output over a larger output area.

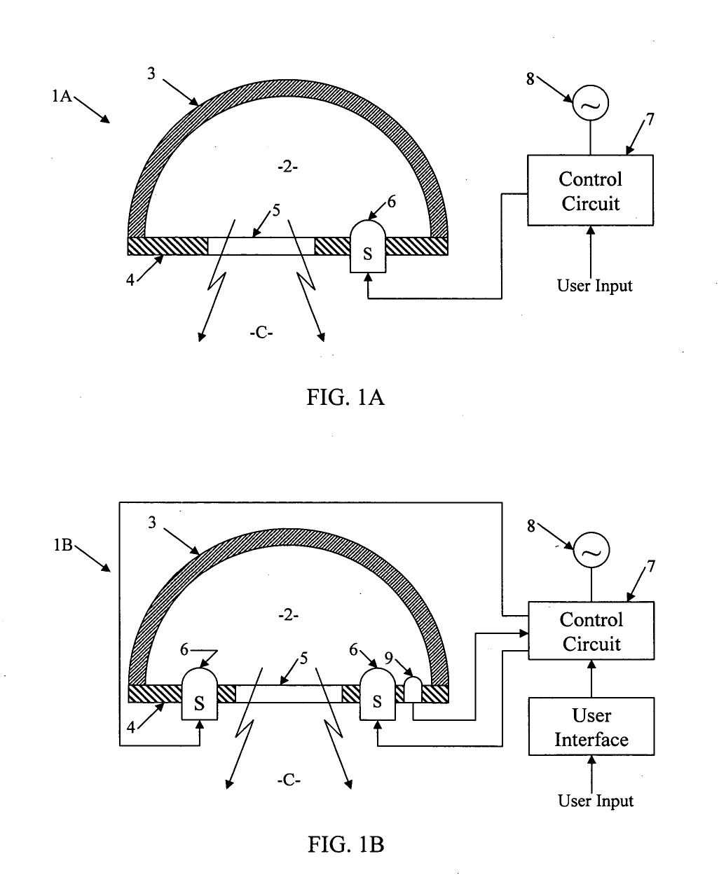

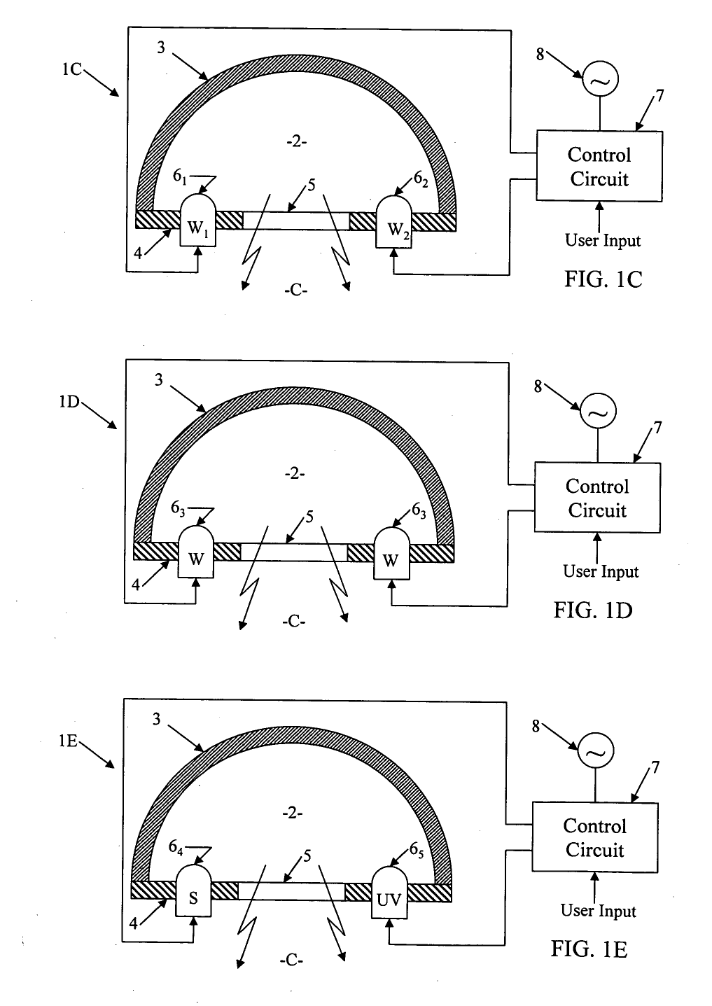

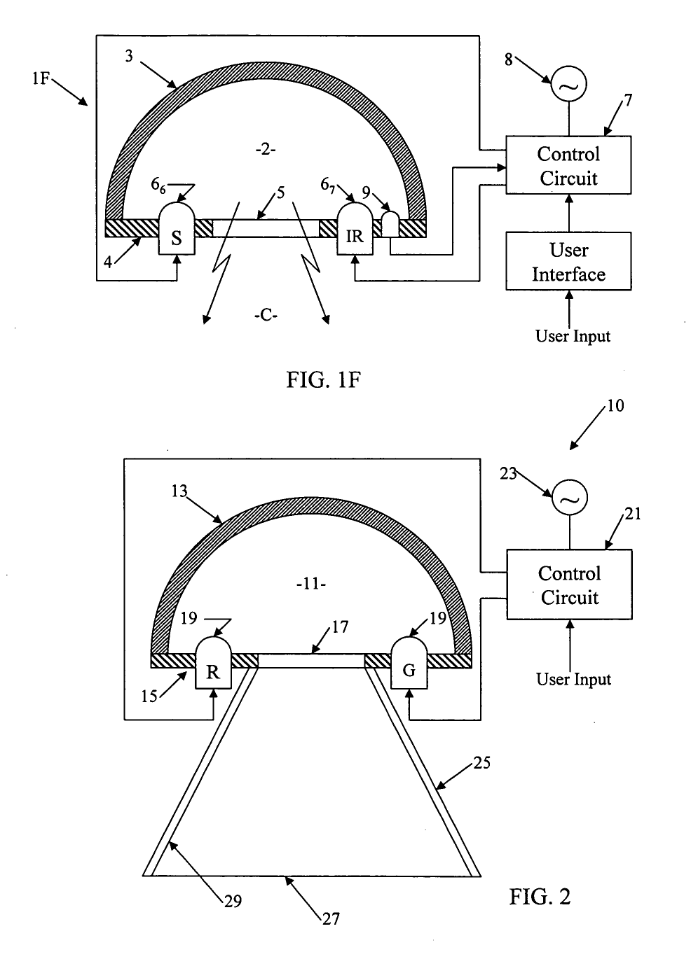

As shown in FIG. 1A, an exemplary lighting system 1A includes an optical integrating cavity 2 having a reflective interior surface. The cavity 2 is a diffuse optical processing element used in the conversion to a virtual source. At least a portion of the interior surface of the cavity 2 exhibits a diffuse reflectivity. The cavity 2 may have various shapes. The illustrated cross-section would be substantially the same if the cavity is hemispherical or if the cavity is semi-cylindrical with a lateral cross-section taken perpendicular to the longitudinal axis. It is desirable that the cavity surface have a highly efficient reflective characteristic, e.g. a reflectivity equal to or greater than 90%, with respect to the relevant wavelengths. The entire interior surface may be diffusely reflective, or one or more substantial portions may be diffusely reflective while other portion(s) of the cavity surface may have different light responsive characteristics. In some examples, one or more other portions are substantially specular.

For purposes of the discussion, the cavity 2 in the system 1A is assumed to be hemispherical. In such an example, a hemispherical dome 3 and a substantially flat cover plate 4 form the optical cavity 2. At least the interior facing surface(s) of the dome 3 is highly diffusely reflective, so that the resulting cavity 2 is highly diffusely reflective with respect to the radiant energy spectrum produced by the system 1. The interior facing surface(s) of the plate are reflective, typically specular or diffusely reflective. The cavity 2 forms an integrating type optical cavity. Although shown as separate elements, the dome and plate may be formed as an integral unit. The cavity 2 has a transmissive optical aperture 5, which allows emission of reflected and diffused light C from within the interior of the cavity 2 into a region to facilitate a humanly perceptible lighting application for the system IA. In the example, the aperture 5 forms the virtual source of the light from system IA.

The lighting system 1A also includes at least one source of radiant electromagnetic energy. The fixture geometry discussed herein may be used with any appropriate type of sources of radiant electromagnetic energy. Although other types of sources of radiant electromagnetic energy may be used, such as various conventional forms of incandescent, arc, neon and fluorescent lamp, at least one source takes the form of a solid state light emitting element (S), represented by the single solid state lighting element (S) 6 in the drawing. In a single source example, the element (S) 6 typically emits visible light. In multisource examples discussed later, some source(s) may emit visible light and one or more other sources may emit light in another part of the electromagnetic spectrum.

Each solid state light emitting element (S) 6 is coupled to supply light to enter the cavity 2 at a point that directs the light toward a reflective surface so that it reflects one or more times inside the cavity 2, and at least one such reflection is a diffuse reflection. In an example where the aperture is open or transparent, the points of emission into the cavity are not directly observable through the aperture 5 from the region illuminated by the fixture output C. Various couplings and various light entry locations may be used. The solid state light emitting element (S) 6 is not perceptible as a point light source of high intensity, from the perspective of an area illuminated by the system 1A.

As discussed herein, applicable solid state light emitting elements (S) essentially include any of a wide range light emitting or generating devices formed from organic or inorganic semiconductor materials. Examples of solid state light emitting elements include semiconductor laser devices and the like. Many common examples of solid state lighting elements, however, are classified as types of “light emitting diodes” or “LEDs.” This exemplary class of solid state light emitting devices encompasses any and all types of semiconductor diode devices that are capable of receiving an electrical signal and producing a responsive output of electromagnetic energy. Thus, the term “LED” should be understood to include light emitting diodes of all types, light emitting polymers, organic diodes, and the like. LEDs may be individually packaged, as in the illustrated examples. Of course, LED based devices may be used that include a plurality of LEDs within one package, for example, multi-die LEDs that contain separately controllable red (R), green (G) and blue (B) LEDs within one package. Those skilled in the art will recognize that “LED” terminology does not restrict the source to any particular type of package for the LED type source. Such terms encompass LED devices that may be packaged or non-packaged, chip on board LEDs, surface mount LEDs, and any other configuration of the semiconductor diode device that emits light. Solid state lighting elements may include one or more phosphors and/or nanophosphors based upon quantum dots, which are integrated into elements of the package or light processing elements of the fixture to convert at least some radiant energy to a different more desirable wavelength or range of wavelengths.

The color or spectral characteristic of light or other electromagnetic radiant energy relates to the frequency and wavelength of the radiant energy and/or to combinations of frequencies/wavelengths contained within the energy. Many of the examples relate to colors of light within the visible portion of the spectrum, although examples also are discussed that utilize or emit other energy. Electromagnetic energy, typically in the form of light energy from the one or more solid state light sources (S) 6, is diffusely reflected and combined within the cavity 2 to form combined light C and form a virtual source of such combined light C at the aperture 5. Such integration, for example, may combine light from multiple sources or spread light from one small source across the broader area of the aperture 5. The integration tends to form a relatively Lambertian distribution across the virtual source. When the system illumination is viewed from the area illuminated by the combined light C, the virtual source at aperture 5 appears to have substantially infinite depth of the integrated light C. Also, the visible intensity is spread uniformly across the virtual source, as opposed to individual small point sources of higher intensity as would be seen if the one or more elements (S) 6 were directly observable without sufficient diffuse processing before emission through the aperture 5.

Pixelation and color striation are problems with many prior solid state lighting devices. When the prior fixture output is observed, the light output from individual LEDs or the like appear as identifiable/individual point sources or ‘pixels.’ Even with diffusers or other forms of common mixing, the pixels of the sources are apparent. The observable output of such a prior system exhibits a high maximum-to-minimum intensity ratio. In systems using multiple light color sources, e.g. RGB LEDs, unless observed from a substantial distance from the fixture, the light from the fixture often exhibits striations or separation bands of different colors.

Systems and light fixtures as disclosed herein, however, do not exhibit such pixilation or striations. Instead, the diffuse optical processing converts the point source output(s) of the one or more solid state light emitting elements to a virtual source output of light C, at the aperture 5 in the examples using optical cavity processing. The virtual source output C is unpixelated and relatively uniform across the apparent output area of the fixture, e.g. across the optical aperture 5 of the cavity 2 in this example. The optical integration sufficiently mixes the light from the solid state light emitting elements 6 that the combined light output C of the virtual source is at least substantially Lambertian in distribution across the optical output area of the fixture, that is to say across the aperture 5 of the cavity 2. As a result, the light output C exhibits a relatively low maximum-to-minimum intensity ratio across the aperture 5. In the examples shown herein, the virtual source light output exhibits a maximum to minimum ratio of 2 to 1 or less over substantially the entire optical output area. The area of the virtual source is at least one order of magnitude larger than the area of the point source output of the solid state emitter 6. The examples rely on various implementations of the optical integrating cavity 2 as the mixing element to achieve this level of output uniformity at the virtual source, however, other mixing elements could be used if they are configured to produce a virtual source with such a uniform output (Lambertian and/or relatively low maximum-to-minimum intensity ratio across the fixture's optical output area).

The diffuse optical processing may convert a single small area (point) source of light from a solid state emitter 6 to a broader area virtual source at the aperture, as shown in FIG. 1A. The diffuse optical processing can also combine a number of such point source outputs to form one virtual source. Examples with multiple solid state sources appear in later drawings.

It also should be appreciated that solid state light emitting elements 6 may be configured to generate electromagnetic radiant energy having various bandwidths for a given spectrum (e.g. narrow bandwidth of a particular color, or broad bandwidth centered about a particular), and may use different configurations to achieve a given spectral characteristic. For example, one implementation of a white LED may utilize a number of dies that generate different primary colors which combine to form essentially white light. In another implementation, a white LED may utilize a semiconductor that generates light of a relatively narrow first spectrum in response to an electrical input signal, but the narrow first spectrum acts as a pump. The light from the semiconductor “pumps” a phosphor material contained in the LED package, which in turn radiates a different typically broader spectrum of light that appears relatively white to the human observer.

The system 1A also includes a controller, shown in the example as a control circuit 7, which is responsive to a user actuation for controlling an amount of radiant electromagnetic energy supplied to the cavity 2 by the solid state light emitting element or elements 6 of the system 1. The control circuit 7 typically includes a power supply circuit coupled to a power source, shown as an AC power source 8. The control circuit 7 also includes one or more adjustable driver circuits for controlling the power applied to the solid state light emitting elements (S) 6 and thus the amount of radiant energy supplied to the cavity 2 by each source 6. The control circuit 7 may be responsive to a number of different control input signals, for example, to one or more user inputs as shown by the arrow in FIG. 1A and possibly signals from one or more sensors. Specific examples of the control circuitry are discussed in more detail later.

FIG. 1B shows another example of a lighting system, that is to say system 1B. The system 1B, for example, includes an optical integrating cavity 2 as the diffuse optical processing element similar to that discussed above relative to FIG. 1A. Again, the cavity 2 formed in the example by the dome 3 and the cover plate 4 has a reflective interior. At least one surface of the interior of the cavity 2 is diffusely reflective, so that the cavity diffusely reflects light and thereby integrates or combines light for a virtual source emission C. The cavity 2 has an optical aperture that appears as the virtual source. The aperture 5 allows emission of reflected light from within the interior of the cavity as combined light for virtual source output at C, which is directed into a region to facilitate a humanly perceptible lighting application for the system 1B.

In this type of exemplary system 1B, there are a number of solid state light emitting elements (S) 6 for emitting light, similar to the element(s) 6 used in the system 1A of FIG. 1A. At least one of the solid state light emitting elements 6 emits visible light energy. The other emitting element 6 typically emits visible light energy, although in some case the other element may produce other spectrums, e.g. in the ultraviolet (UV) or infrared (IR) portions of the electromagnetic spectrum. Each of the solid state light emitting elements (S) 6 supplies light (visible, UV or IR) into the cavity 2 at a point whereby direct light emissions will reflect one or more times inside the cavity. Where the aperture 5 is transparent, the initial emission or light entry points to the cavity are not directly observable through the aperture from the illuminated region. The reflections serve to integrate or combine light from the sources and to spread the combined light uniformly across the aperture 5. Light from each source 6 diffusely reflects at least once inside the cavity 2 before emission as part of the virtual source output light C that emerges through the aperture 5. The diffuse processing by the cavity thus combines and spreads the light from the point source outputs of the solid state emitters 6 over the larger area of the aperture 5 so that the aperture forms a virtual source.

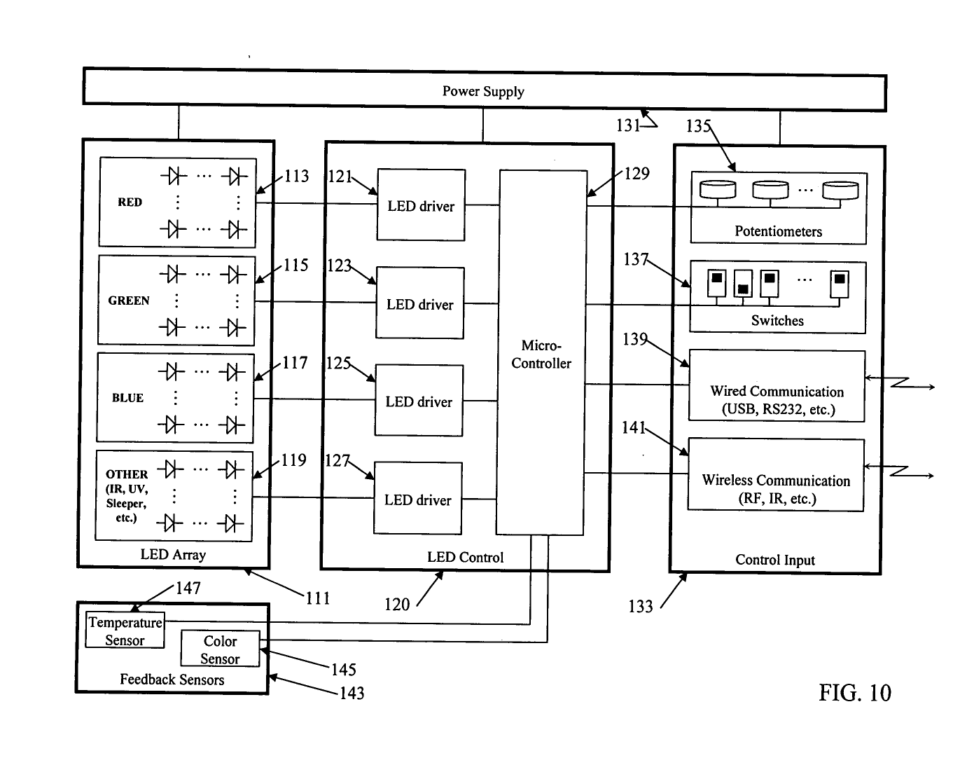

The system may also include a user interface device for providing the means for user input. The exemplary system 1B also includes a sensor 9 for detecting a characteristic of the reflected light from within the interior of the cavity 2. The sensor 9, for example, may detect intensity of the combined light in the cavity 2. As another example, the sensor may provide some indication of the spectral characteristic of the combined light in the cavity 2. The controller 7 is generally similar to that shown in FIG. 1A and discussed above. However, in this example, the controller 7 is responsive both to a user input of a selected desired light characteristic and to an indication of the characteristic of the reflected light from within the interior of the cavity 2 provided by the sensor 9. In response, the controller 7 controls the amount of light supplied to the cavity by each of the solid state light emitting elements 6. Detailed examples of the user interface, the sensor and the responsive control circuit are discussed below relative to FIG. 10.

Some systems that use multiple solid state light emitting elements (S) 6 may use sources 6 of the same type, that is to say a set of solid state light emitting sources that all produce electromagnetic energy of substantially the same spectral characteristic. All of the sources may be identical white light (W) emitting elements or may all emit light of the same primary color. The system 1C (FIG. 1C) includes multiple white solid state emitting (S) 6₁ and 6₂. Although the two white light emitting elements could emit the same color temperature of white light, in this example, the two elements 6 emit white light of two different color temperatures.

The system 1C is generally similar to the system 1A discussed above, and similarly numbered elements have similar structures, arrangements and functions. However, in the system 1C the first solid state light emitting element 61 is a white LED W₁ of a first type, for emitting white light of a first color temperature, whereas the second solid state light emitting element 6₂ is a white LED W₂ of a second type, for emitting white light of a somewhat different second color temperature. Controlled combination of the two types of white light within the cavity 2 allows for some color adjustment, to achieve a color temperature of the combined light output C of the virtual source that is somewhere between the temperatures of the two white lights, depending on the amount of each white light provided by the two elements 6₁ and 6₂.

FIG. 1D illustrates another system example 1D. The system 1D is similar to the system 1C discussed above, and similarly numbered elements have similar structures, arrangements and functions. However, in the system 1D the multiple solid state light emitting elements 6₃ are white light emitters of the same type. Although the actual spectral output of the emitters 6₃ may vary somewhat from device to device, the solid state light emitting elements 6₃ are of a type intended to emit white light of substantially the same color temperature. The diffuse processing and combination of light from the solid state white light emitting elements 63 provides a uniform white light output over the area of the aperture 5, that is to say at the virtual source, much like in the other embodiment of FIG. 1C. However, because the emitting elements 6₃ all emit white light of substantially the same color temperature, the virtual source output light C also has substantially the same color temperature.

Although applicable to all of the embodiments, it may be helpful at this point to consider an advantage of the fixture geometry and virtual source conversion in a bit more detail, with regard to the white light examples, particularly that of FIG. 1D. The solid state light emitting elements 6 represent point sources. The actual area of light emission from each element 6 is relatively small. The actual light emitting chip area may be only a few square millimeters or less in area. The LED packaging often provides some diffusion, but this only expands the source area a bit, to tens or hundreds of millimeters. Such a concentrated point source output may be potentially hazardous if viewed directly. Where there are multiple solid state sources, when viewed directly, the sources appear as multiple bright light point sources.

The processing within the cavity 2, however, combines and spreads the light from the solid state light emitting elements 6 for virtual source output via the much larger area of the aperture 5. An aperture 5 with a two (2) inch radius represents a virtual source area of 12.6 square inches. Although the aperture 5 may still appear as a bright virtual light source, the bright light over the larger area will often represent a reduced hazard. The integration by the optical cavity also combines the point source light to form a uniform distribution at the virtual source. The uniform distribution extends over the optical output area of the virtual source, the area of aperture 5 in the example, which is larger than the combined areas of outputs of the point sources of light from the solid state emitters 6. The intensity at any point in the virtual source will be much less that that observable at the point of emission of one of the solid state light emitting elements 6. In the examples, the cavity 2 serves as an optical processing element to diffuse the light from the solid state light emitting element 6 over the virtual source output area represented by the aperture 5, to produce a light output through the optical output area that is sufficiently uniform across the virtual source area as to appear as an unpixelated light output.

FIGS. 1E and 1F illustrate additional system examples, which include at least one solid state light emitting element for emitting light outside the visible portion of the electromagnetic spectrum. The system 1E is similar to the systems discussed above, and similarly numbered elements have similar structures, arrangements and functions. In the system 1E, one solid state light emitting element 6₄ emits visible light, whereas another solid state light emitting element 6₅ emits ultraviolet (UV) light. The cavity 2 reflects, diffuses combines and spreads visible and UV light from the solid state light emitting element 6₄ and 6₅ for virtual source emission C via the aperture 5, in essentially the same manner as in the earlier visible light examples.

The system 1F is similar to the systems discussed above, particularly the system 1B of FIG. 1B, and similarly numbered elements have similar structures, arrangements and functions. In the system 1F, one solid state light emitting element 6₆ emits visible light, whereas another solid state light emitting element 67 emits infrared (IR) light. The cavity 2 reflects, diffuses, spreads and combines visible and IR light from the solid state light emitting element 6₆ and 6₇ for virtual source emission in essentially the same manner as in the earlier examples. The sensor 9 in this example may detect visible light and/or IR light, depending on the needs of a particular application.

Applications are also disclosed that utilize sources of two, three or more different types of light sources, that is to say solid state light sources that produce electromagnetic energy of two, three or more different spectral characteristics. Many such examples include sources of visible red (R) light, visible green (G) light and visible blue (B) light or other combinations of primary colors of light. Controlled amounts of light from primary color sources can be combined to produce light of many other visible colors, including various temperatures of white light. It may be helpful now to consider several more detailed examples of lighting systems using solid state light emitting elements. A number of the examples, starting with that of FIG. 2 use RGB LEDs or similar sets of devices for emitting three or more colors of visible light for combination within the optical integrating cavity and virtual source emission.

FIG. 2 is a cross-sectional illustration of a radiant energy distribution apparatus or system 10. For task lighting applications and the like, the apparatus emits light in the visible spectrum, although the system 10 may be used for rumination applications and/or with emissions in or extending into the infrared and/or ultraviolet portions of the radiant energy spectrum.

The illustrated system 10 includes an optical cavity 11 having a diffusely reflective interior surface, to receive and diffusely process radiant energy of different colors/wavelengths. The cavity 11 may have various shapes. The illustrated cross-section would be substantially the same if the cavity is hemispherical or if the cavity is semi-cylindrical with the cross-section taken perpendicular to the longitudinal axis. The optical cavity in the examples discussed below is typically an optical integrating cavity.

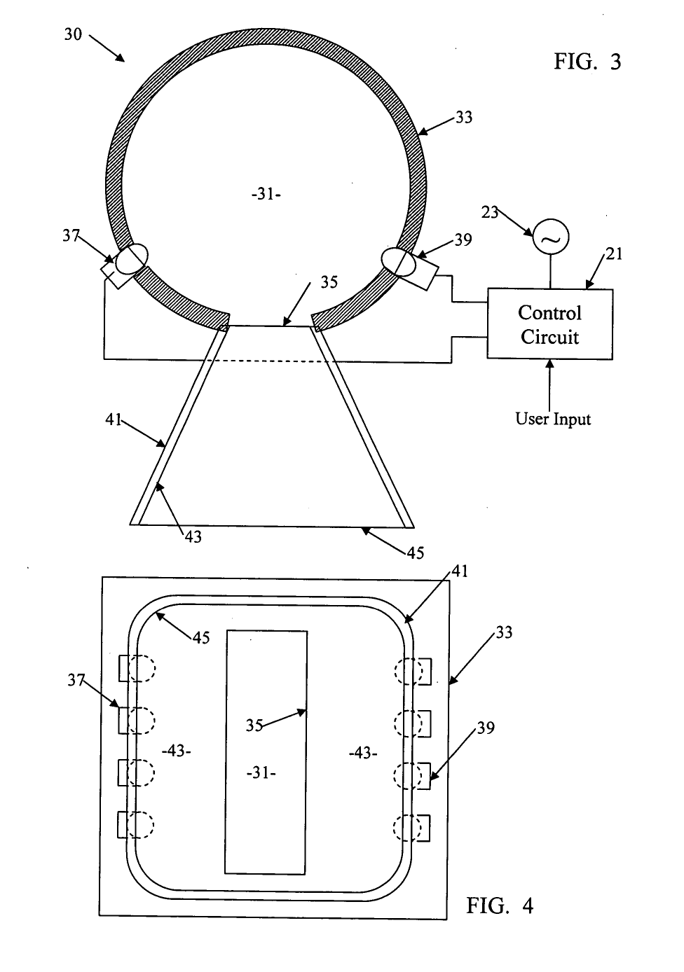

The disclosed apparatus may use a variety of different structures or arrangements for the optical integrating cavity, examples of which are discussed below relative to FIGS. 3-9 and 15a-24. At least a substantial portion of the interior surface(s) of the cavity exhibit(s) diffuse reflectivity. It is desirable that the cavity surface have a highly efficient reflective characteristic, e.g. a reflectivity equal to or greater than 90%, with respect to the relevant wavelengths. In the example of FIG. 2, the surface is highly diffusely reflective to energy in the visible, near-infrared, and ultraviolet wavelengths.

The cavity 11 may be formed of a diffusely reflective plastic material, such as a polypropylene having a 97% reflectivity and a diffuse reflective characteristic. Such a highly reflective polypropylene is available from Ferro Corporation—Specialty Plastics Group, Filled and Reinforced Plastics Division, in Evansville, Ind. Another example of a material with a suitable reflectivity is SPECTRALON. Alternatively, the optical integrating cavity may comprise a rigid substrate having an interior surface, and a diffusely reflective coating layer formed on the interior surface of the substrate so as to provide the diffusely reflective interior surface of the optical integrating cavity. The coating layer, for example, might take the form of a flat-white paint or white powder coat. A suitable paint might include a zinc-oxide based pigment, consisting essentially of an uncalcined zinc oxide and preferably containing a small amount of a dispersing agent. The pigment is mixed with an alkali metal silicate vehicle-binder, which preferably is a potassium silicate, to form the coating material. For more information regarding the exemplary paint, attention is directed to U.S. patent application Ser. No. 09/866,516, which was filed May 29, 2001, by Matthew Brown, which issued as U.S. Pat. No. 6,700,112 on Mar. 2, 2004.

For purposes of the discussion, the cavity 11 in the apparatus 10 is assumed to be hemispherical. In the example, a hemispherical dome 13 and a substantially flat cover plate 15 form the optical cavity 11. At least the interior facing surfaces of the dome 13 and the cover plate 15 are highly diffusely reflective, so that the resulting cavity 11 is highly diffusely reflective with respect to the radiant energy spectrum produced by the device 10. As a result, the cavity 11 is an integrating type optical cavity. Although shown as separate elements, the dome and plate may be formed as an integral unit. For example, rectangular cavities are discussed later in which the dome and plate are elements of a unitary extruded member.

The optical integrating cavity 11 has an aperture 17 for allowing emission of combined radiant energy. In the example, the optical aperture 17 is a passage through the approximate center of the cover plate 15, although the aperture may be at any other convenient location on the plate 15 or the dome 13. Because of the diffuse reflectivity within the cavity 11, light within the cavity is integrated or combined before passage out of the aperture 17. As in the earlier examples, this diffuse processing of light produces a virtual light source at the aperture 17. If as illustrated the actual sources emit light of two or more different colors, the virtual source appears as a source of a color of light that results from the combination of the colors from the actual sources.

The integration produces a highly uniform light distribution across the aperture 17 of the cavity 11, which forms the virtual output area and often forms all or a substantial part of the output area of the fixture. Typically, the distribution of light across the aperture 17 is substantially Lambertian. During operation, when viewed from the area illuminated by the combined light, the aperture 17 appears to be a light source of substantially infinite depth of the combined color of light. Also, the visible intensity is spread uniformly across the aperture 17, as opposed to individual small point sources as would be seen if the one or more of the light emitting elements were directly visible. This conversion to a virtual source, by spreading of the light over the aperture area, reduces or eliminates hazards from direct view of intense solid state point sources. The virtual source fixture output is relatively uniform across the apparent output area of the virtual source, e.g. across the optical aperture 17 of the cavity 11. Typically, the virtual source light output exhibits a relatively low maximum-to-minimum intensity ratio across the area of the aperture 17. In the example, the virtual source light output exhibits a maximum-to-minimum ratio of 2 to 1 (2:1) or less over substantially the entire virtual source optical output area represented by the aperture 17.

In the examples, the apparatus 10 is shown emitting the radiant energy downward from the virtual source, that is to say downward through the aperture 17, for convenience. However, the apparatus 10 may be oriented in any desired direction to perform a desired application function, for example to provide visible luminance to persons in a particular direction or location with respect to the fixture or to illuminate a different surface such as a wall, floor or table top. Also, the optical integrating cavity 11 may have more than one aperture 17, for example, oriented to allow emission of integrated light in two or more different directions or regions.

The apparatus 10 also includes solid state light emission sources of radiant energy of different wavelengths. In this example, the solid state sources are LEDs 19, two of which are visible in the illustrated cross-section. The LEDs 19 supply radiant energy into the interior of the optical integrating cavity 11. As shown, the points of emission into the interior of the optical integrating cavity are not directly visible through the aperture 17. Direct emissions from the LEDs 19 are directed toward the diffusely reflective inner surface of the dome 13, so as to diffusely reflect at least once within the cavity 11 before emission in the combined light passing out of the cavity through the aperture 17. At least the two illustrated LEDs 19 emit radiant energy of different wavelengths, e.g. Red (R) and Green (G). Additional LEDs of the same or different colors may be provided. The cavity 11 effectively integrates the energy of different wavelengths, so that the integrated or combined radiant energy emitted through the aperture 17 forms a virtual source of light that includes the radiant energy of all the various wavelengths in relative amounts substantially corresponding to the relative amounts of input into the cavity 11 from the respective LEDs 19.

The source LEDs 19 can include LEDs of any color or wavelength. Typically, an array of LEDs for a visible light application includes at least red, green, and blue LEDs. The integrating or mixing capability of the cavity 11 serves to project light of any color, including white light, by adjusting the intensity of the various sources coupled to the cavity. Hence, it is possible to control color rendering index (CRI), as well as color temperature. The system 10 works with the totality of light output from a family of LEDs 19. However, to provide color adjustment or variability, it is not necessary to control the output of individual LEDs, except as they contribute to the totality. For example, it is not necessary to modulate the LED outputs, although modulation may be used if desirable for particular applications. Also, the distribution pattern of the individual LEDs and their emission points into the cavity are not significant. The LEDs 19 can be arranged in any manner to supply radiant energy within the cavity, although it is preferred that direct view of the LEDs from outside the fixture is minimized or avoided.

In this example, light outputs of the LED sources 19 are coupled directly to openings at points on the interior of the cavity 11, to emit radiant energy directly into the interior of the optical integrating cavity. Direct emissions are aimed at a reflective surface of the cavity. The LEDs 19 may be located to emit light at points on the interior wall of the element 13, although preferably such points would still be in regions out of the direct line of sight through the aperture 17. For ease of construction, however, the openings for the LEDs 19 are formed through the cover plate 15. On the plate 15, the openings/LEDs may be at any convenient locations. From such locations, all or substantially all of the direct emissions from the LEDs 19 impact on the internal surface of the dome 13 and are diffusely reflected.

The apparatus 10 also includes a control circuit 21 coupled to the LEDs 19 for establishing output intensity of radiant energy of each of the LED sources. The control circuit 21 typically includes a power supply circuit coupled to a source, shown as an AC power source 23. The control circuit 21 also includes an appropriate number of LED driver circuits for controlling the power applied to each of the different color LEDs 19 and thus the amount of radiant energy supplied to the cavity 11 for each different wavelength. It is possible that the power could be modulated to control respective light amounts output by the LEDs, however, in the examples, LED outputs are controlled by controlling the amount of power supplied to drive respective LEDs. Such control of the amount of light emission of the sources sets a spectral characteristic of the combined radiant energy emitted through the aperture 17 of the optical integrating cavity. The control circuit 21 may be responsive to a number of different control input signals, for example, to one or more user inputs as shown by the arrow in FIG. 2. Although not shown in this simple example, feedback may also be provided. Specific examples of the control circuitry are discussed in more detail later.

The aperture 17 may serve as the system output, directing integrated color light of relatively uniform intensity distribution to a desired area or region to be illuminated. Although not shown in this example, the aperture 17 may have a grate, lens or diffuser (e.g. a holographic element) to help distribute the output light and/or to close the aperture against entry of moisture of debris. For some applications, the system 10 includes an additional deflector to distribute and/or limit the light output to a desired field of illumination. A later embodiment, for example, uses a colliminator.

The exemplary apparatus shown in FIG. 2 also comprises a deflector 25 having a reflective inner surface, to efficiently direct most of the light emerging from a light source into a relatively narrow field of view. A small opening at a proximal end of the deflector is coupled to the aperture 17 of the optical integrating cavity 11. The deflector 25 has a larger opening 27 at a distal end thereof. Although other shapes may be used, the deflector 25 is conical. The angle and distal opening of the conical deflector 25 define an angular field of radiant energy emission from the apparatus 10. Although not shown, the large opening of the deflector may be covered with a transparent plate or lens, or covered with a grating, to prevent entry of dirt or debris through the cone into the system and/or to further process the output radiant energy.

The conical deflector may have a variety of different shapes, depending on the particular lighting application. In the example, where cavity 11 is hemispherical, the cross-section of the conical deflector is typically circular. However, the deflector may be somewhat oval in shape. In applications using a semi-cylindrical cavity, the deflector may be elongated or even rectangular in cross-section. The shape of the aperture 17 also may vary, but will typically match the shape of the small end opening of the deflector 25. Hence, in the example, the aperture 17 would be circular. However, for a device with a semi-cylindrical cavity and a deflector with a rectangular cross-section, the aperture may be rectangular.

The deflector 25 comprises a reflective interior surface 29 between the distal end and the proximal end. In some examples, at least a substantial portion of the reflective interior surface 29 of the conical deflector exhibits specular reflectivity with respect to the integrated radiant energy. As discussed in U.S. Pat. No. 6,007,225, for some applications, it may be desirable to construct the deflector 25 so that at least some portion(s) of the inner surface 29 exhibit diffuse reflectivity or exhibit a different degree of specular reflectivity (e.g., quasi-secular), so as to tailor the performance of the deflector 25 to the particular application. For other applications, it may also be desirable for the entire interior surface 29 of the deflector 25 to have a diffuse reflective characteristic. In such cases, the deflector 25 may be constructed using materials similar to those taught above for construction of the optical integrating cavity 11.

In the illustrated example, the large distal opening 27 of the deflector 25 is roughly the same size as the cavity 11. In some applications, this size relationship may be convenient for construction purposes. However, a direct relationship in size of the distal end of the deflector and the cavity is not required. The large end of the deflector may be larger or smaller than the cavity structure. As a practical matter, the size of the cavity is optimized to provide the integration or combination of light colors from the desired number of LED sources 19. The size, angle and shape of the deflector determine the area that will be illuminated by the combined or integrated light emitted from the cavity 11 via the aperture 17.

In the example, each solid state source of radiant energy of a particular wavelength comprises one or more light emitting diodes (LEDs). Within the chamber, it is possible to process light received from any desirable number of such LEDs. Hence, in several examples including that of FIG. 2, the sources may comprise one or more LEDs for emitting light of a first color, and one or more LEDs for emitting light of a second color, wherein the second color is different from the first color. Each LED represents a point source of a particular color, which in the RGB example, is one of three primary colors. The diffuse processing converts the point source lights to a single combined virtual source light at the aperture. In a similar fashion, the apparatus may include additional sources comprising one or more LEDs of a third color, a fourth color, etc.; and the diffuse processing combines those additional lights into the virtual source light output. To achieve the highest color rendering index (CRI) at the virtual source output, the LED array may include LEDs of various wavelengths that cover virtually the entire visible spectrum. Examples with additional sources of substantially white light are discussed later.

FIGS. 3 and 4 illustrate another example of a radiant energy distribution apparatus or system. FIG. 3 shows the overall system 30, including the fixture and the control circuitry. The fixture is shown in cross-section. FIG. 4 is a bottom view of the fixture. The system 30 is generally similar the system 10. For example, the system 30 may utilize essentially the same type of control circuit 21 and power source 23, as in the earlier example. However, the shape of the optical integrating cavity and the deflector are somewhat different.

The optical integrating cavity 31 has a diffusely reflective interior surface. In this example, the cavity 31 has a shape corresponding to a substantial portion of a cylinder. In the cross-sectional view of FIG. 3 (taken across the longitudinal axis of the cavity), the cavity 31 appears to have an almost circular shape. Although a dome and curved member or plate could be used, in this example, the cavity 31 is formed by a substantially cylindrical element 33. At least the interior surface of the element 33 is highly diffusely reflective, so that the resulting optical cavity 31 is highly diffusely reflective. The optical cavity 31 functions as an integrating cavity, with respect to the radiant energy spectrum produced by the system 30.

The optical integrating cavity 31 has an aperture 35 for allowing emission of combined radiant energy. In this example, the aperture 35 is a rectangular passage through the wall of the cylindrical element 33. Because of the diffuse reflectivity within the cavity 31, light within the cavity is integrated before passage out of the aperture 35. This processing converts the light inputs in the cavity into a virtual source at the output aperture. As in the earlier examples, the combination of light within the cavity 31 produces a relatively uniform intensity distribution across the output area formed by the aperture 35. Typically, the distribution is substantially Lambertian and the integration produces a highly uniform light distribution across the aperture 17 of the cavity 11, which forms the virtual source area of the cavity 11 and often forms all or a substantial part of the optical output area of the fixture. Typically, the unpixelated distribution of light across the virtual source at the aperture 17 exhibits a maximum-to-minimum ratio of 2 to 1 (2:1) or less over substantially the entire optical output area.

The apparatus 30 also includes solid state sources of radiant energy of different wavelengths. In this example, the sources comprise LEDs 37, 39. The LEDs are mounted in openings through the wall of the cylindrical element 33, to essentially form two rows of LEDs on opposite sides of the aperture 35. The positions of these openings, and thus the positions of the LEDs 37 and 39, typically are such that the LED outputs initially impact on a reflective cavity surface and are not directly visible through the aperture 35, otherwise the locations are a matter of arbitrary choice.

Thus, the LEDs 37 and 39 supply radiant energy into the interior of the optical integrating cavity 31, through openings at points on the interior surface of the optical integrating cavity for diffuse reflective processing inside the cavity 31. A number of the LEDs emit radiant energy of different wavelengths. For example, arbitrary pairs of the LEDs 37, 39 might emit four different colors of light, e.g. Red, Green and Blue as primary colors and a fourth color chosen to provide an increased variability of the spectral characteristic of the integrated radiant energy. One or more white light sources, e.g. white LEDs, also may be provided.

Alternatively, a number of the LEDs may be initially active LEDs, whereas others are initially inactive sleeper LEDs. The sleeper LEDs offer a redundant capacity that can be automatically activated on an as-needed basis. For example, the initially active LEDs might include two Red LEDs, two Green LEDs and a Blue LED; and the sleeper LEDs might include one Red LED, one Green LED and one Blue LED.

The control circuit 21 controls the power provided to each of the LEDs 37 and 39. The cavity 31 effectively combines the energy of different wavelengths, from the various LEDs 37 and 39, so that the integrated radiant energy emission from the aperture 35 forms a virtual source of light that includes the radiant energy of all the various wavelengths. Control of the intensity of emission of the sources, by the control circuit 21, sets a spectral characteristic of the radiant energy of the virtual source output emitted through the aperture 35. If sleeper LEDs are provided, the control also activates one or more dormant LEDs, on an “as-needed” basis, when extra output of a particular wavelength or color is required.

The energy distribution apparatus 30 may also include a deflector 41 having a specular or other type of reflective inner surface 43, to efficiently direct most of the light emerging from the aperture into a relatively narrow field of view. The deflector 41 expands outward from a small end thereof coupled to the aperture 35. The deflector 41 has a larger opening 45 at a distal end thereof. The angle of the side walls of the deflector and the shape of the distal opening 45 of the deflector 41 define an angular field of radiant energy emission from the apparatus 30.

As noted above, the deflector may have a variety of different shapes, depending on the particular lighting application. In the example, where the cavity 31 is substantially cylindrical, and the aperture is rectangular, the cross-section of the deflector 41 (viewed across the longitudinal axis as in FIG. 3) typically appears conical, since the deflector expands outward as it extends away from the aperture 35. However, when viewed on-end (bottom view —FIG. 4), the openings are substantially rectangular, although they may have somewhat rounded corners. Alternatively, the deflector 41 may be somewhat oval in shape. The shapes of the cavity and the aperture may vary, for example, to have rounded ends, and the deflector may be contoured to match the aperture.

The deflector 41 comprises a reflective interior surface 43 between the distal end and the proximal end. In several examples, at least a substantial portion of the reflective interior surface 43 of the conical deflector exhibits specular reflectivity with respect to the combined radiant energy, although different reflectivity may be provided, as noted in the discussion of FIG. 2.

If redundancy is provided, “sleeper” LEDs would be activated only when needed to maintain the light output, color, color temperature, and/or thermal temperature. As discussed later with regard to an exemplary control circuit, the system 30 could have a color sensor coupled to provide feedback to the control circuit 21. The sensor could be within the cavity or the deflector or at an outside point illuminated by the integrated light from the fixture.

As LEDs age, they continue to operate, but at a reduced output level. The use of the sleeper LEDs greatly extends the lifecycle of the fixtures. Activating a sleeper (previously inactive) LED, for example, provides compensation for the decrease in output of the originally active LED. There is also more flexibility in the range of intensities that the fixtures may provide.

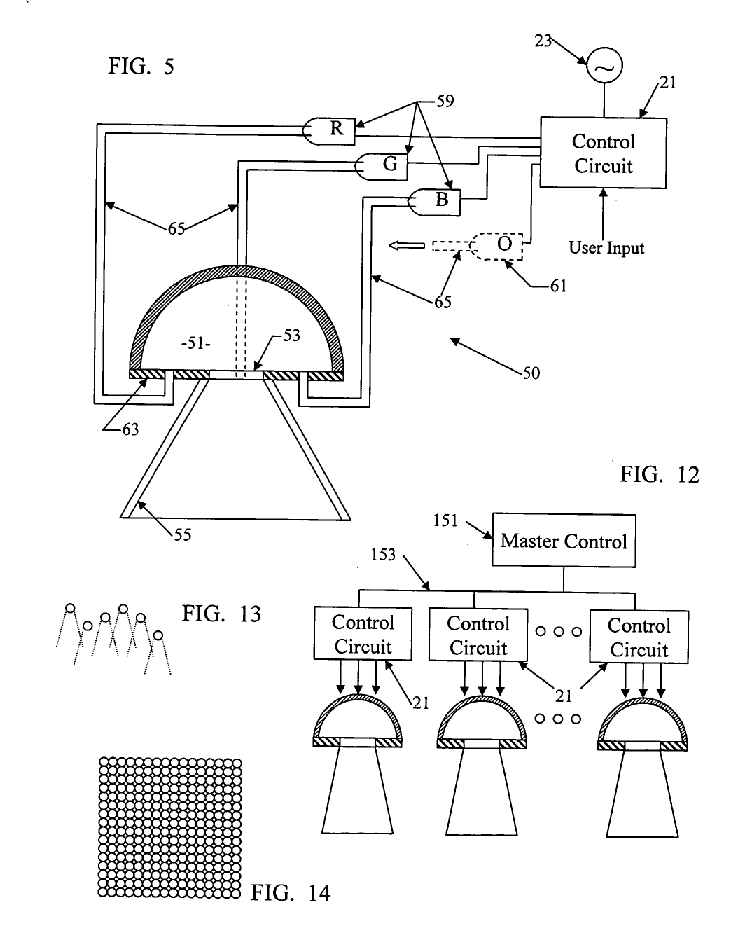

In the examples discussed above relative to FIG. 2 to 4, the LED sources were coupled directly to openings at the points on the interior of the cavity, to emit radiant energy directly into the interior of the optical integrating cavity. It is also envisioned that the sources may be somewhat separated from the cavity, in which case, the device might include optical fibers or other forms of light guides coupled between the sources and the optical integrating cavity, to supply radiant energy from the sources to the emission points into the interior of the cavity. In a similar fashion, the diffuse processing of light from the fibers converts those point sources to a combined relatively large area virtual source output. FIG. 5 depicts such a system 50, which uses optical fibers.

The system 50 includes an optical integrating cavity 51, an aperture 53 and a deflector with a reflective interior surface 55, similar to those in earlier embodiments. The interior surface of the optical integrating cavity 51 is highly diffusely reflective, whereas the deflector surface 55 exhibits a specular reflectivity. Integration or combination of light by diffuse reflection within the cavity 51 produces a relatively uniform unpixelated virtual source output via the aperture 53. Typically, the distribution at the aperture 53 is substantially Lambertian, and the diffusion inside the cavity produces a highly uniform light distribution across the aperture 53, which forms the virtual source area of the system and often forms all or a substantial part of the output area of the fixture. Typically, the unpixelated distribution of light across the virtual source formed at the aperture 53 exhibits a maximum-to-minimum ratio of 2 to 1 (2:1) or less over substantially the entire optical output area.

The system 50 includes a control circuit 21 and power source 23, as in the earlier embodiments. In the system 50, the radiant energy sources comprise LEDs 59 of three different wavelengths, e.g. to provide Red, Green and Blue light respectively. The sources may also include one or more additional LEDs 61, either white or of a different color or for use as ‘sleepers,’ similar to the example of FIGS. 3 and 4. In this example (FIG. 5), the cover plate 63 of the cavity 51 has openings into which are fitted the light emitting distal ends of optical fibers 65. The proximal light receiving ends of the fibers 65 are coupled to receive light emitted by the LEDs 59 (and 61 if provided). In this way, the LED sources 59, 61 may be separate from the chamber 51, for example, to allow easier and more effective dissipation of heat from the LEDs. The fibers 65 transport the light from the LED sources 59, 61 to the cavity 51. The cavity 51 integrates the different colors of light from the LEDs as in the earlier examples and supplies combined light out through the virtual source formed at the aperture 53. The deflector, in turn, directs the combined light from the virtual source to a desired field. Again, the LED control by the circuit 21 adjusts the amount or intensity of the light of each type provided by the LED sources and thus controls the spectral characteristic of the virtual source light output.

A number of different examples of control circuits are discussed below. In one example, the control circuitry comprises a color sensor coupled to detect color distribution in the integrated radiant energy. Associated logic circuitry, responsive to the detected color distribution, controls the output intensity of the various LEDs, so as to provide a desired color distribution in the integrated radiant energy. In an example using sleeper LEDs, the logic circuitry is responsive to the detected color distribution to selectively activate the inactive light emitting diodes as needed, to maintain the desired color distribution in the integrated radiant energy.

To provide a uniform output distribution from the apparatus, it is also possible to construct the optical cavity so as to provide constructive occlusion. Constructive Occlusion type transducer systems utilize an electrical/optical transducer optically coupled to an active area of the system, typically the aperture of a cavity or an effective aperture formed by a reflection of the cavity. The systems utilize diffusely reflective surfaces, such that the active area exhibits a substantially Lambertian characteristic. A mask occludes a portion of the active area of the system, in the examples, the aperture of the cavity or the effective aperture formed by the cavity reflection, in such a manner as to achieve a desired response or output performance characteristic for the system. In examples of the present systems using constructive occlusion, the optical integrating cavity comprises a base, a mask and a cavity in either the base or the mask. The mask would have a diffusely reflective surface facing toward the aperture. The mask is sized and positioned relative to the active area so as to constructively occlude the active area. It may be helpful to consider two examples using constructive occlusion.

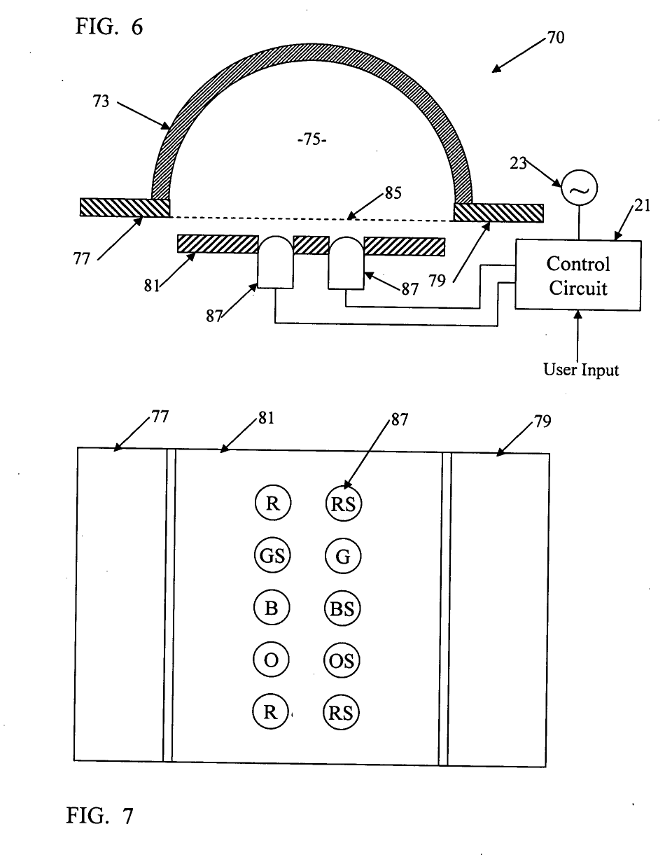

FIGS. 6 and 7 depict a first, simple embodiment of a light distributor apparatus or system 70, for virtual source distribution of integrated multi-wavelength light with a tailored intensity distribution, using the principles of constructive occlusion. In the cross-section illustration, the system 70 is oriented to provide downward illumination. Such a system might be mounted in or suspended from a ceiling or canopy or the like. Those skilled in the art will recognize that the designer may choose to orient the system 70 in different directions, to adapt the system to other lighting applications.

The lighting system 70 includes a base 73, having or forming a cavity 75, and adjacent shoulders 77 and 79, constructed in a manner similar to the elements forming integrating cavities in the earlier examples. In particular, the interior of the cavity 75 is diffusely reflective, and the down-facing surfaces of shoulders 77 and 79 may be reflective. If the shoulder surfaces are reflective, they may be specular or diffusely reflective. A mask 81 is disposed between the cavity aperture 85 and the field to be illuminated. In this symmetrical embodiment, the interior wall of a half-cylindrical base 73 forms the cavity; therefore the aperture 85 is rectangular. The shoulders 77 formed along the sides of the aperture 85 are rectangular. If the base were circular, with a hemispherical cavity, the shoulders typically would form a ring that may partially or completely surround the aperture.

In many constructive occlusion embodiments, the cavity 75 comprises a substantial segment of a sphere. For example, the cavity may be substantially hemispherical, as in earlier examples. However, the cavity's shape is not of critical importance. A variety of other shapes may be used. In the illustrated example, the half-cylindrical cavity 75 has a rectangular aperture, and if extended longitudinally, the rectangular aperture may approach a nearly linear aperture (slit). Practically any cavity shape is effective, so long as it has a diffuse reflective inner surface. A hemisphere or the illustrated half-cylinder shape are preferred for the ease in modeling for the light output toward the field of intended illumination and the attendant ease of manufacture. Also, sharp corners tend to trap some reflected energy and reduce output efficiency.

For purposes of constructive occlusion, the base 73 may be considered to have an active optical area, preferably exhibiting a substantially Lambertian energy distribution. Where the cavity is formed in the base, for example, the planar aperture 85 formed by the rim or perimeter of the cavity 75 forms the active surface with substantially Lambertian distribution of energy emerging through the aperture. As shown in a later embodiment, the cavity may be formed in the facing surface of the mask. In such a system, the surface of the base may be a diffusely reflective surface, therefore the active area on the base would essentially be the mirror image of the cavity aperture on the base surface, that is to say the area reflecting energy emerging from the physical aperture of the cavity in the mask.

The mask 81 constructively occludes a portion of the optically active area of the base with respect to the field of intended illumination. In the example of FIG. 6, the optically active area is the aperture 85 of the cavity 75; therefore the mask 81 occludes a substantial portion of the aperture 85, including the portion of the aperture on and about the axis of the mask and cavity system. The surface of the mask 81 facing towards the aperture 85 is reflective. Although it may be specular, typically this surface is diffusely reflective.

The relative dimensions of the mask 81 and aperture 85, for example the relative widths (or diameters or radii in a more circular system) as well as the distance of the mask 81 away from the aperture 85, control the constructive occlusion performance characteristics of the lighting system 70. Certain combinations of these parameters produce a relatively uniform emission intensity with respect to angles of emission, over a wide portion of the field of view about the system axis (vertically downward in FIG. 6), covered principally by the constructive occlusion. Other combinations of size and height result in a system performance that is uniform with respect to a wide planar surface perpendicular to the system axis at a fixed distance from the active area.

The shoulders 77, 79 also are reflective and therefore deflect at least some light downward. The shoulders (and side surfaces of the mask) provide additional optical processing of combined light from the cavity. The angles of the shoulders and the reflectivity of the surfaces thereof facing toward the region to be illuminated by constructive occlusion also contribute to the intensity distribution over that region. In the illustrated example, the reflective shoulders are horizontal, although they may be angled somewhat downward from the plane of the aperture.

With respect to the energy from the solid state light emitting elements (e.g. LEDs 87), the interior space formed between the cavity 75 and the facing surface of the mask 81 operates as an optical integrating cavity, in essentially the same manner as the integrating cavities in the previous embodiments. The LEDs could provide light of one color, e.g. white. In the example, the LEDs 87 provide light of a number of different colors, and thus of different wavelengths. The optical cavity combines the light of multiple colors supplied from the LEDs 87. The control circuit 21 controls the amount of each color of light supplied to the chamber and thus the proportion thereof included in the combined output light. The constructive occlusion serves to distribute that light in a desired manner over a field or area that the system 70 is intended to illuminate, with a tailored intensity distribution.

The LEDs 87 could be located at (or coupled by optical fiber to emit light) from any location or part of the surface of the cavity 75. Preferably, the LED outputs are directed toward a reflective surface and are not directly visible through the un-occluded portions of the aperture 85 (between the mask and the edge of the cavity). In examples of the type shown in FIGS. 6 and 7, the easiest way to so position the LED outputs is to mount the LEDs 87 (or provide fibers or the like) so as to supply light to the chamber through openings through the mask 81. The un-occluded portions of the aperture form a virtual source of processed light output, as did the apertures in the earlier examples.

FIG. 7 also provides an example of an arrangement of the LEDs in which there are both active and inactive (sleeper) LEDs of the various colors. As shown, the active part of the array of LEDs 87 includes two Red LEDs (R), one Green LED (G) and one Blue LED (B). The initially inactive part of the array of LEDs 87 includes two Red sleeper LEDs (RS), one Green sleeper LED (GS) and one Blue sleeper LED (BS). If other wavelengths or white light sources are desired, the apparatus may include an active LED of the other color (O) as well as a sleeper LED of the other color (OS). The precise number, type, arrangement and mounting technique of the LEDs and the associated ports through the mask 81 are not critical. The number of LEDs, for example, is chosen to provide a desired level of output energy (intensity), for a given application.

The system 70 includes a control circuit 21 and power source 23. These elements control the operation and output intensity of each LED 87. The individual intensities determine the amount of each color light included in the integrated and distributed output. The control circuit 21 functions in essentially the same manner as in the other examples.

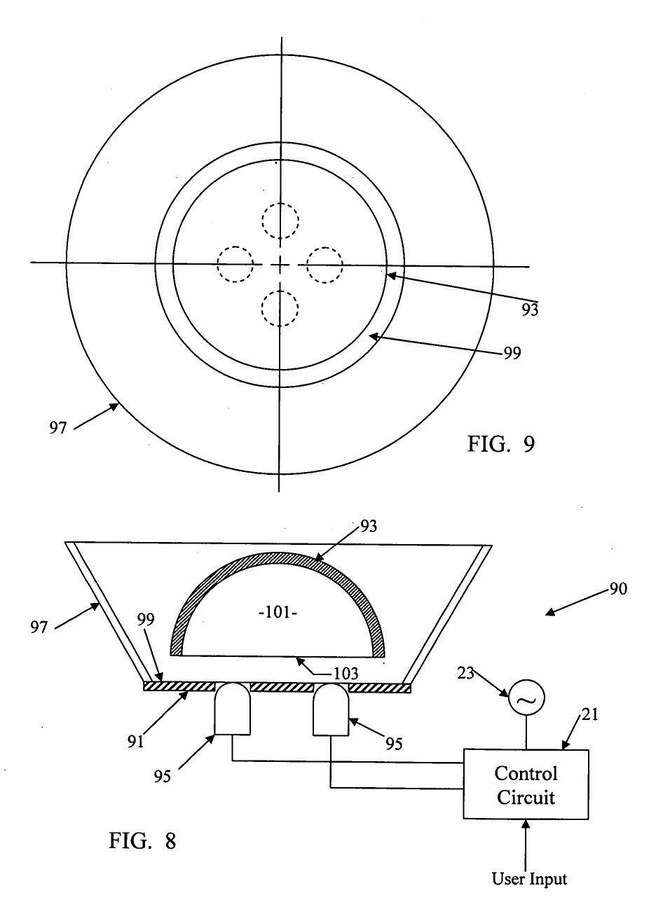

FIGS. 8 and 9 illustrate a second constructive occlusion example. In this example, the physical cavity is actually formed in the mask, and the active area of the base is a flat reflective panel of the base.

The illustrated system 90 comprises a flat base panel 91, a mask 93, LED light sources 95, and a conical deflector 97. The system 90 is circularly symmetrical about a vertical axis, although it could be rectangular or have other shapes. The base 91 includes a flat central region 99 between the walls of the deflector 97. The region 99 is reflective and forms or contains the active optical area on the base facing toward the region or area to be illuminated by the system 90.

The mask 93 is positioned between the base 91 and the region to be illuminated by constructive occlusion. For example, in the orientation shown, the mask 93 is above the active optical area 99 of the base 91, for example to direct light toward a ceiling for indirect illumination. Of course, the mask and cavity system could be inverted to serve as a downlight for task lighting applications, or the mask and cavity system could be oriented to emit light in directions appropriate for other applications.

In this example, the mask 93 contains the diffusely reflective cavity 101, constructed in a manner similar to the integrating cavities in the earlier examples. The physical aperture 103 of the cavity 101 and of any diffusely reflective surface(s) of the mask 93 that may surround that aperture form an active optical area on the mask 93. Such an active area on the mask faces away from the region to be illuminated and toward the active surface 99 on the base 91. The surface 99 is reflective, preferably with a diffuse characteristic. The surface 99 of the base 91 essentially acts to produce a diffused mirror image of the mask 93 with its cavity 101 as projected onto the base area 99. The reflection formed by the active area of the base becomes the effective aperture of the optical integrating cavity (between the mask and base) when the fixture is considered from the perspective of the area of intended illumination. The surface area 99 reflects energy emerging from the aperture 103 of the cavity 101 in the mask 93. The mask 93 in turn constructively occludes light diffused from the active base surface 99 with respect to the region illuminated by the system 90 and forms a virtual source output in a manner similar to the example of FIGS. 6 and 7. The dimensions and relative positions of the mask and active region on the base control the performance of the system, in essentially the same manner as in the mask and cavity system of FIGS. 6 and 7.

The system 90 includes a control circuit 21 and associated power source 23, for supplying controlled electrical power to the LED type solid state sources 95. In this example, the LEDs emit light through openings through the base 91, preferably at points not directly visible from outside the system. LEDs of the same type, emitting the same color of light, could be used. However, in the example, the LEDs 95 supply various wavelengths of light, and the circuit 21 controls the power of each LED, to control the amount of each color of light in the combined output, as discussed above relative to the other examples.

The base 91 could have a flat ring-shaped shoulder with a reflective surface. In this example, however, the shoulder is angled toward the desired field of illumination to form a conical deflector 97. The inner surface of the deflector 97 is reflective, as in the earlier examples.

The deflector 97 has the shape of a truncated cone, in this example, with a circular lateral cross section. The cone has two circular openings. The cone tapers from the large end opening to the narrow end opening, which is coupled to the active area 99 of the base 91. The narrow end of the deflector cone receives light from the surface 99 and thus from diffuse reflections between the base and the mask.

The entire area of the inner surface of the cone 97 is reflective. At least a portion of the reflective surface is specular, as in the deflectors of the earlier examples. The angle of the wall(s) of the conical deflector 97 substantially corresponds to the angle of the desired field of view of the illumination intended for the system 90. Because of the reflectivity of the wall of the cone 97, most if not all of the light reflected by the inner surface thereof would at least achieve an angle that keeps the light within the field of view.

In the illustrated example, the LED light sources 95 emit multiple wavelengths of light into the mask cavity 101. The light sources 95 may direct some light toward the inner surface of the deflector 97. Light rays impacting on the diffusely reflective surfaces, particularly those on the inner surface of the cavity 101 and the facing surface 99 of the base 91, reflect and diffuse one or more times within the confines of the system and emerge as the virtual light source, i.e., as emitted through the gap between the perimeter of the active area 99 of the base and the outer edge of the mask 93. The mask cavity 101 and the base surface 99 function as an optical integrating cavity with respect to the light of various wavelengths, and the gap becomes the actual integrating cavity aperture from which substantially uniform combined light emerges as a virtual source of the combined light. The light emitted through the gap and/or reflected from the surface of the inner surface of the deflector 97 irradiates a region (upward in the illustrated orientation) with a desired intensity distribution and with a desired spectral characteristic, essentially as in the earlier examples.

Additional information regarding constructive occlusion based systems for generating and distributing radiant energy may be found in commonly assigned U.S. Pat. Nos. 6,342,695, 6,334,700, 6,286,979, 6,266,136 and 6,238,077. The color integration principles discussed herein may be adapted to any of the constructive occlusion devices discussed in those patents.

The inventive devices have numerous applications, and the output intensity and spectral characteristic of the light of the virtual source may be tailored and/or adjusted to suit the particular application. For example, the intensity of the integrated radiant energy emitted by the virtual source may be at a level for use in a rumination application or at a level sufficient for a task lighting application or other type of general lighting application. A number of other control circuit features also may be implemented. For example, the control may maintain a set color characteristic in response to feedback from a color sensor. The control circuitry may also <include a temperature sensor. In such an example, the logic circuitry is also responsive to the sensed temperature, e.g. to reduce intensity of the source outputs to compensate for temperature increases. The control circuitry may include a user interface device or receive signals from a separate user interface device, for manually setting the desired spectral characteristic. For example, an integrated user interface might include one or more variable resistors or one or more dip switches directly connected into the control circuitry, to allow a user to define or select the desired color distribution and/or intensity.

Automatic controls also are envisioned. For example, the control circuitry may include a data interface coupled to the logic circuitry, for receiving data defining the desired intensity and/or color distribution. Such an interface would allow input of control data from a separate or even remote device, such as a personal computer, personal digital assistant or the like. A number of the devices, with such data interfaces, may be controlled from a common central location or device.

The control may be somewhat static, e.g. set the desired color reference index or desired color temperature and the overall intensity, and leave the device set-up in that manner for an indefinite period. The apparatus also may be controlled dynamically, for example, to provide special effects lighting. Where a number of the devices are arranged in a large two-dimensional array, dynamic control of color and intensity of each unit could even provide a video display capability, for example, for use as a “Jumbo Tron” view screen in a stadium or the like. In product lighting or in personnel lighting (for studio or theater work), the lighting can be adjusted for each product or person that is illuminated. Also, such light settings are easily recorded and reused at a later time or even at a different location using a different system.

To appreciate the features and examples of the control circuitry outlined above, it may be helpful to consider specific examples with reference to appropriate diagrams. As noted in the discussions of FIGS. 1A to 2, the conversion to a virtual source is applicable to systems using one or more solid state sources of a single color of light as well as to systems using sources of two or more colors of radiant energy. For discussion purposes, the circuit examples show systems using sources of multiple colors of visible light.

FIG. 10 is a block diagram of exemplary circuitry for the sources and associated control circuit, providing digital programmable control, which may be utilized with a virtual source light fixture of the type described above. In this circuit example, the solid state sources of radiant energy of the various types take the form of an LED array 111. Arrays of one, two or more colors may be used. The illustrated array 111 comprises two or more LEDs of each of the three primary colors, red green and blue, represented by LED blocks 113, 115 and 117. For example, the array may comprise six Red LEDs 113, three Green LEDs 115 and three Blue LEDs 117.

The LED array 111 in this example also includes a number of additional or “other” LEDs 119. There are several types of additional LEDs that are of particular interest in the present discussion. One type of additional LED provides one or more additional wavelengths of radiant energy for integration within the chamber. The additional wavelengths may be in the visible portion of the light spectrum, to allow a greater degree of color adjustment of the virtual source light output. Alternatively, the additional wavelength LEDs may provide energy in one or more wavelengths outside the visible spectrum, for example, in the infrared (IR) range or the ultraviolet (UV) range.

The second type of additional LED that may be included in the system is a sleeper LED. As discussed above, some LEDs would be active, whereas the sleepers would be inactive, at least during initial operation. Using the circuitry of FIG. 10 as an example, the Red LEDs 113, Green LEDs 115 and Blue LEDs 117 might normally be active. The LEDs 119 would be sleeper LEDs, typically including one or more LEDs of each color used in the particular system.

The third type of other LED of interest is a white LED. The entire array 111 may consist of white LEDs of one, two or more color temperatures. For white lighting applications using primary color LEDs (e.g. RGB LEDs as shown), one or more additional white LEDs provide increased intensity; and the primary color LEDs then provide light for color adjustment and/or correction.

The electrical components shown in FIG. 10 also include an LED control system 120. The system 120 includes driver circuits 121 to 127 for the various LEDs 113 to 119 and a microcontroller 129. The driver circuits 121 to 127 supply electrical current to the respective LEDs 113 to 119 to cause the LEDs to emit visible light or other radiant energy. The driver circuit 121 drives the Red LEDs 113, the driver circuit 123 drives the Green LEDs 115, and the driver circuit 125 drives the Blue LEDs 117. In a similar fashion, when active, the driver circuit 127 provides electrical current to the other LEDs 119. If the other LEDs provide another color of light, and are connected in series, there may be a single driver circuit 127. If the LEDs are sleepers, it may be desirable-to provide a separate driver circuit 127 for each of the LEDs 119 or at least for each set of LEDs of a different color.

The control circuit could modulate outputs of the LEDs by modulating the respective drive signals. In the example, the intensity of the emitted light of a given LED is proportional to the level of current supplied by the respective driver circuit. The current output of each driver circuit is controlled by the higher level logic of the system. In this digital control example, that logic is implemented by the programmable microcontroller 129, although those skilled in the art will recognize that the logic could take other forms, such as discrete logic components, an application specific integrated circuit (ASIC), etc. Although not separately shown, digital to analog converters (DACs) may be utilized to convert control data outputs from the microcontroller 129 to analog control signal levels for control of the LED driver circuits.

The LED driver circuits and the microcontroller 129 receive power from a power supply 131, which is connected to an appropriate power source (not separately shown). For most task-lighting applications and the like, the power source will be an AC line current source, however, some applications may utilize DC power from a battery or the like. The power supply 129 converts the voltage and current from the source to the levels needed by the driver circuits 121 -127 and the microcontroller 129.

A programmable microcontroller typically includes or has coupled thereto random-access memory (RAM) for storing data and read-only memory (ROM) and/or electrically erasable read only memory (EEROM) for storing control programming and any pre-defined operational parameters, such as pre-established light ‘recipes’ or dynamic color variation ‘routines.’ The microcontroller 129 itself comprises registers and other components for implementing a central processing unit (CPU) and possibly an associated arithmetic logic unit. The CPU implements the program to process data in the desired manner and thereby generates desired control outputs to cause the system to generate a virtual source of a desired output characteristic.

The microcontroller 129 is programmed to control the LED driver circuits 121-127 to set the individual output intensities of the LEDs to desired levels, so that the combined light emitted from the aperture of the cavity has a desired spectral characteristic and a desired overall intensity. The microcontroller 129 may be programmed to implement an algorithm to convert color and/or intensity settings received as input data to appropriate driver settings for the respective groups 113 to 119 of the LEDs in the array 111. The microcontroller 129 may be programmed to essentially establish and maintain or preset a desired ‘recipe’ or mixture of the available wavelengths provided by the LEDs used in the particular system. For some applications, the microcontroller may work through a number of settings over a period of time in a manner defined by a dynamic routine. The microcontroller 129 receives control inputs or retrieves a stored set of values specifying the particular ‘recipe’ or mixture, as will be discussed below. To insure that the desired mixture is maintained, the microcontroller 129 receives a color feedback signal and possibly an overall intensity signal, from an appropriate sensor. The microcontroller 129 may also be responsive to a feedback signal from a temperature sensor, for example, in or near the optical cavity or other processing element that performs the conversion to a virtual source.

The electrical system will also include one or more control inputs 133 for inputting information instructing the microcontroller 129 as to the desired operational settings. A number of different types of inputs may be used and several alternatives are illustrated for convenience. A given installation may include a selected one or more of the illustrated control input mechanisms.

As one example, user inputs may take the form of a number of potentiometers 135. The number would typically correspond to the number of different light wavelengths provided by the particular LED array 111. The potentiometers 135 typically connect through one or more analog to digital conversion interfaces provided by the microcontroller 129 (or in associated circuitry). To set the parameters for the integrated light output, the user adjusts the potentiometers 135 to set the intensity for each color. The microcontroller 129 senses the input settings and controls the LED driver circuits accordingly, to set corresponding intensity levels for the LEDs providing the light of the various wavelengths.

Another user input implementation might utilize one or more dip switches 137. For example, there might be a series of such switches to input a code corresponding to one of a number of recipes or to a stored dynamic routine. The memory used by the microcontroller 129 would store the necessary intensity levels for the different color LEDs in the array 111 for each recipe and/or for the sequence of recipes that make up a routine. Based on the input code, the microcontroller 129 retrieves the appropriate recipe from memory. Then, the microcontroller 129 controls the LED driver circuits 121-127 accordingly, to set corresponding intensity levels for the LEDs 113-119 providing the light of the various wavelengths.

As an alternative or in addition to the user input in the form of potentiometers 135 or dip switches 137, the microcontroller 129 may be responsive to control data supplied from a separate source or a remote source. For that purpose, some versions of the system will include one or more communication interfaces. One example of a general class of such interfaces is a wired interface 139. One type of wired interface typically enables communications to and/or from a personal computer or the like, typically within the premises in which the fixture operates. Examples of such local wired interfaces include USB, RS-232, and wire-type local area network (LAN) interfaces. Other wired interfaces, such as appropriate modems, might enable cable or telephone line communications with a remote computer, typically outside the premises. Other examples of data interfaces provide wireless communications, as represented by the interface 141 in the drawing. Wireless interfaces, for example, use radio frequency (RF) or infrared (IR) links. The wireless communications may be local on-premises communications, analogous to a wireless local area network (WLAN). Alternatively, the wireless communications may enable communication with a remote device outside the premises, using wireless links to a wide area network.

As noted above, the electrical components may also include one or more feedback sensors 143, to provide system performance measurements as feedback signals to the control logic, implemented in this example by the microcontroller 129. A variety of different sensors may be used, alone or in combination, for different applications. In the illustrated examples, the set 143 of feedback sensors includes a color sensor 145 and a temperature sensor 147. Although not shown, other sensors, such as an overall intensity sensor may be used. The sensors are positioned in or around the system to measure the appropriate physical condition, e.g. temperature, color, intensity, etc.

The color sensor 145, for example, is coupled to detect color distribution in the integrated radiant energy. The color sensor may be coupled to sense energy within the optical integrating cavity, within the deflector (if provided) or at a point in the field illuminated by the particular system. Various examples of appropriate color sensors are known. For example, the color sensor may be a digital compatible sensor, of the type sold by TAOS, Inc. Another suitable sensor might use the quadrant light detector disclosed in U.S. Pat. No. 5,877,490, with appropriate color separation on the various light detector elements (see U.S. Pat. No. 5,914,487 for discussion of the color analysis).

The associated logic circuitry, responsive to the detected color distribution, controls the output intensity of the various LEDs, so as to provide a desired color distribution in the integrated radiant energy, in accord with appropriate settings. In an example using sleeper LEDs, the logic circuitry is responsive to the detected color distribution to selectively activate the inactive light emitting diodes as needed, to maintain the desired color distribution in the integrated radiant energy. The color sensor measures the color of the integrated radiant energy produced by the system and provides a color measurement signal to the microcontroller 129. If using the TAOS, Inc. color sensor, for example, the signal is a digital signal derived from a color to frequency conversion, wherein the pulse frequency corresponds to measured intensity. The TAOs sensor is responsive to instructions from the microcontroller 129 to selectively measure overall intensity, Red intensity, Green intensity and Blue intensity.

The temperature sensor 147 may be a simple thermoelectric transducer with an associated analog to digital converter, or a variety of other temperature detectors may be used. The temperature sensor is positioned on or inside of the fixture, typically at a point that is near the LEDs or other sources that produce most of the system heat. The temperature sensor 147 provides a signal representing the measured temperature to the microcontroller 129. The system logic, here implemented by the microcontroller 129, can adjust intensity of one or more of the LEDs in response to the sensed temperature, e.g. to reduce intensity of the source outputs to compensate for temperature increases. The program of the microcontroller 129, however, would typically manipulate the intensities of the various LEDs so as to maintain the desired color balance between the various wavelengths of light used in the system, even though it may vary the overall intensity with temperature. For example, if temperature is increasing due to increased drive current to the active LEDs (with increased age or heat), the controller may deactivate one or more of those LEDs and activate a corresponding number of the sleepers, since the newly activated sleeper(s) will provide similar output in response to lower current and thus produce less heat.

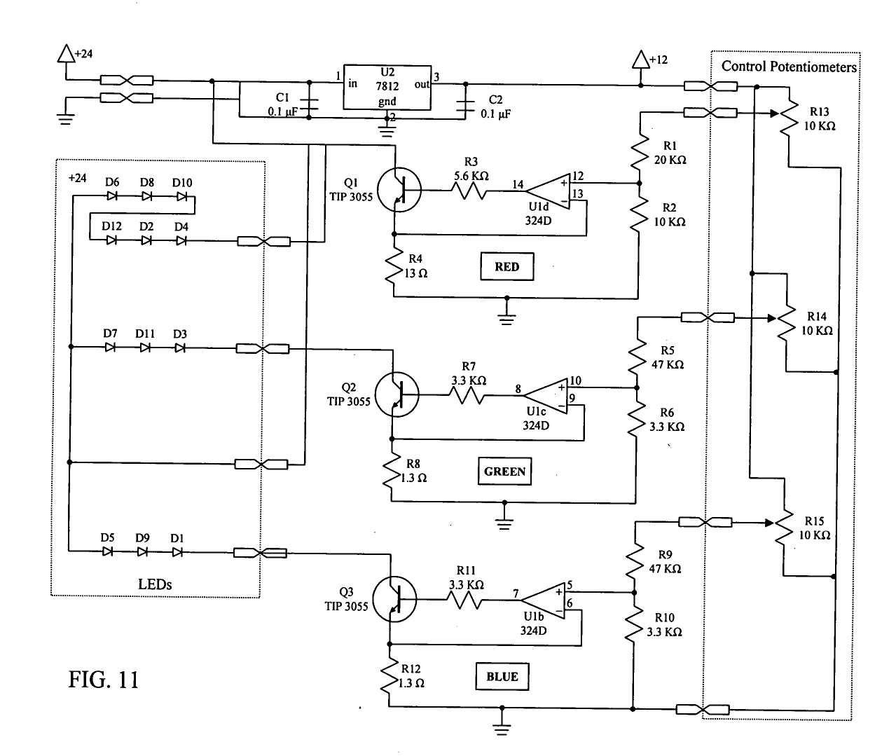

The above discussion of FIG. 10 related to programmed digital implementations of the control logic. Those skilled in the art will recognize that the control also may be implemented using analog circuitry. FIG. 11 is a circuit diagram of a simple analog control for a lighting apparatus (e.g. of the type shown in FIG. 2) using Red, Green and Blue LEDs. The user establishes the levels of intensity for each type of radiant energy emission (Red, Green or Blue) by operating a corresponding one of the potentiometer. The circuitry essentially comprises driver circuits for supplying adjustable power to two or three sets of LEDs (Red, Green and Blue) and analog logic circuitry for adjusting the output of each driver circuit in accord with the setting of a corresponding potentiometer to provide the desired virtual source output. Additional potentiometers and associated circuits would be provided for additional colors of LEDs. Those skilled in the art should be able to implement the illustrated analog driver and control logic of FIG. 11 without further discussion.

The virtual source lighting systems described above have a wide range of applications, where there is a desire to set or adjust color and/or intensity provided by a virtual source output of a lighting fixture. These include task lighting applications, signal light applications, as wells as applications for illuminating an object or person. Some lighting applications involve a common overall control strategy for a number of the systems. As noted in the discussion of FIG. 10, the control circuitry may include a communication interface 139 or 141 allowing the microcontroller 129 to communicate with another processing system. FIG. 12 illustrates an example in which control circuits 21 of a number of the radiant energy generation systems with the light integrating and distribution type fixture communicate with a master control unit 151 via a communication network 153. The master control unit 151 typically is a programmable computer with an appropriate user interface, such as a personal computer or the like. The communication network 153 may be a LAN or a wide area network, of any desired type. The communications allow an operator to control the color and output intensity of all of the linked systems, for example to provide combined lighting effects.

The commonly controlled virtual source lighting systems may be arranged in a variety of different ways, depending on the intended use of the systems. FIG. 13 for example, shows a somewhat random arrangement of virtual source lighting systems. The circles represent the virtual source outputs of those systems, such as the cavity aperture or the large openings of the system deflectors. The dotted lines represent the fields of the emitted radiant energy. Such an arrangement of virtual source lighting systems might be used to throw desired lighting on a wall or other object and may allow the user to produce special lighting effects at different times. Another application might involve providing different color lighting for different speakers during a television program, for example, on a news program, panel discussion or talk show.

The commonly controlled virtual source light emission systems also may be arranged in a two-dimensional array or matrix. FIG. 14 shows an example of such an array. Again, circles represent the output openings of those systems. In this example of an array, the virtual source outputs are tightly packed. Each virtual source output may serve as a color pixel of a large display system. Dynamic control of the outputs therefore can provide a video display screen, of the type used as jumbo-trons in stadiums or the like.

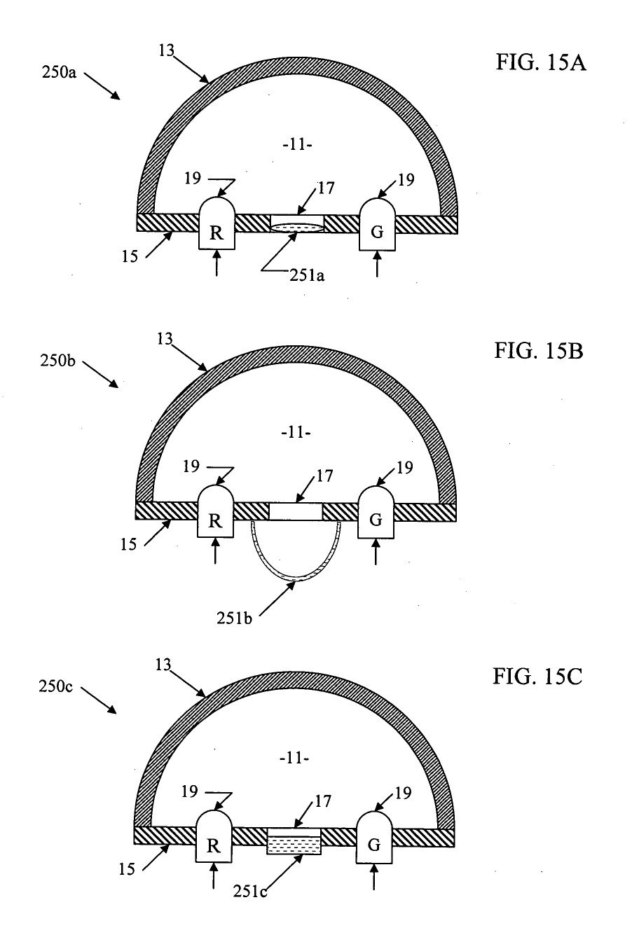

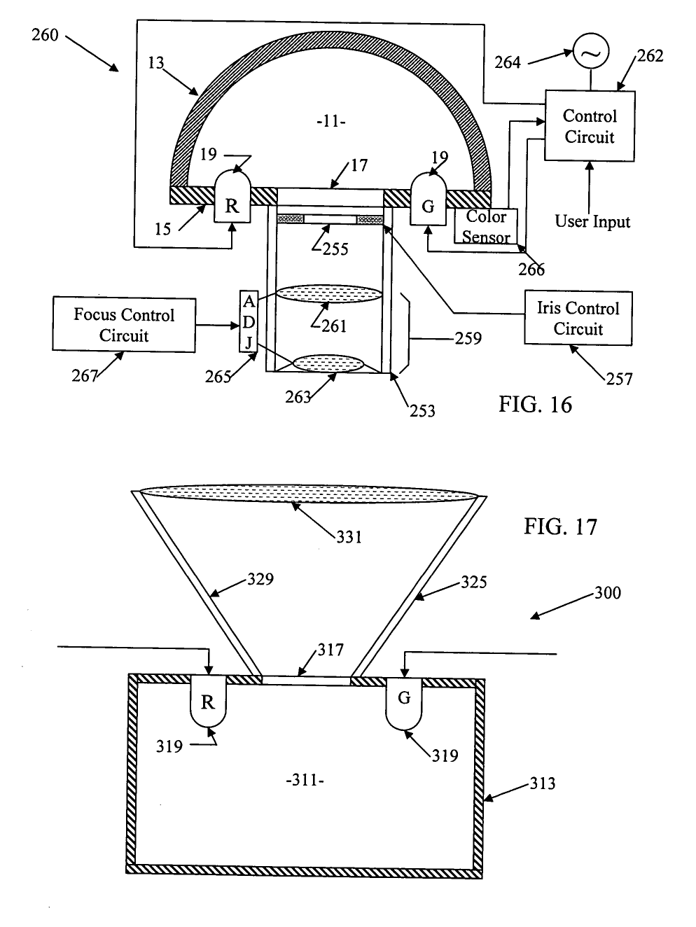

In the examples above, a deflector, mask or shoulder was used to provide further optical processing of the integrated light emitting from the virtual source. A variety of other optical processing devices may be used in place of or in combination with any of those optical processing elements. Examples include various types of diffusers, collimators, variable focus mechanisms, and iris or aperture size control mechanisms. Several of these examples are shown in FIGS. 15-16.

FIGS. 15A to 15C are cross-sectional views of several examples of optical cavity LED fixtures using various forms of secondary optical processing elements to process the integrated energy emitted through the aperture. Although similar fixtures may process and emit other radiant energy spectra, for discussion here we will assume these “lighting” fixtures process and emit light in the visible part of the spectrum. These first three examples are similar to each other, and the common aspects are described first. Each fixture 250 (250a to 250c in FIGS. 15A to 15C, respectively) includes an optical integrating cavity and LEDs similar to those in the example of FIG. 2 and like reference numerals are used to identify the corresponding components. Integration or combination of light by diffuse reflection within the cavity produces a relatively uniform unpixelated virtual source at the aperture 17. Typically, the virtual source distribution at the aperture 17 is substantially Lambertian, and the integration produces a highly uniform light distribution across the aperture, which forms the virtual source area of the system. Typically, the unpixelated distribution of light across the virtual source area exhibits a maximum-to-minimum ratio of 2 to 1 (2:1) or less over substantially the entire virtual source output area. A power source and control circuit similar to those used in the earlier examples provide the drive currents for the LEDs, and in view of the similarity, the power source and control circuit are omitted from these drawings, to simplify the illustrations.

In the examples of FIGS. 15A to 15C, each light fixture 250a to 250c includes an optical integrating cavity 11, formed by a dome 11 and a cover plate 15. The surfaces of the dome 13 and cover 15 forming the interior'surface(s) of the cavity 11 are diffusely reflective. One or more apertures 17, in these examples formed through the plate 15, provide a light passage for transmission of reflected and integrated light outward from the cavity 11. Materials, positions, orientations and possible shapes for the elements 11 to 17 and the resulting combined and unpixelated virtual source light output provided at the aperture 17 have been discussed above.

As in several earlier examples, each fixture 250a to 250c includes a number of LEDs 19 emitting light of different wavelengths into the cavity 11, as in the example of FIG. 2. A number of the LEDs will be active, from initial start-up, whereas others may initially be inactive 'sleepers,‘as also discussed above. The possible combinations and positions of the LEDs 19 have been discussed in detail above, in relation to the earlier examples. Again, the LEDs 19 emit light of multiple colors into the interior of the optical integrating cavity. Control of the amplitudes of the drive currents applied to the LEDs 19 controls the amount of each light color supplied into the cavity 11. The cavity 11 integrates the various amounts of light of the different colors into a combined light for virtual source emission through the aperture 17.

The three examples (FIGS. 15A to 15C) differ as to the processing element coupled to the aperture that processes the integrated color light output coming out of the aperture 17. In the example of FIG. 15A, instead of a deflector as in FIG. 2, the fixture 250a includes a lens 251a in or covering the aperture 17. The lens may take any convenient form, for focusing or diffusing the virtual source light output, as desired for a particular application of the fixture 250a. The lens 251a may be clear or translucent.

In the example of FIG. 15B, the fixture 250b includes a curved transmissive diffuser 251a covering the aperture 17. The diffuser may take any convenient form, for example, a white or clear dome of plastic or glass. Alternatively, the dome may be formed of a prismatic material. In addition to covering the aperture, the element 251b diffuses the virtual source light output, as desired for a particular application of the fixture 250b. The dome shaped diffuser may cover just the aperture, as shown at 251b, or it may cover the backs of the LEDs 19 as well.

In the example of FIG. 15C, a holographic diffraction plate or grading 251c serves as the optical output processing element in the fixture 250c. The holographic grating is another form of diffuser. The holographic diffuser 251c is located in the aperture 17 or attached to the plate 15 to cover the aperture 17. A holographic diffuser provides more precise control over the diffuse area of illumination and increases transmission efficiency. Holographic diffusers and/or holographic films are available from a number of manufacturers, including Edmund Industrial Optics of Barrington, N.J.

Those skilled in the art will recognize that still other light processing elements may be used in place of the output lens 251a, the diffuser 251b and the holographic diffuser 251c, to process or guide the integrated light output from the virtual source. For example, a fiber optic bundle may be used to channel the light to a desired point, for example representing a pixel on a large display screen (e.g. a jumbo tron).

The exemplary systems discussed herein may have any size desirable for any particular application. A system may be relatively large, for lighting a room or providing spot or flood lighting. The system also may be relatively small, for example, to provide a small pinpoint of light, for an indicator or the like. The system 250a, with or even without the lens, is particularly amenable to miniaturization. For example, instead of a plate to support the LEDs, the LEDs could be manufactured on a single chip. If it was not convenient to provide the aperture through the chip, the aperture could be formed through the reflective dome.

FIG. 16 illustrates another example of a “lighting” system 260 with an optical integrating cavity LED light fixture, having yet other elements to optically process the combined color light output from the cavity. The system 260 includes an optical integrating cavity and LEDs similar to those in the examples of FIGS. 1A to 1C, 2 and 15, and like reference numerals are used to identify the corresponding components.

In the example of FIG. 16, the light fixture includes an optical integrating cavity 11, formed by a dome 11 and a cover plate 15. The surfaces of the dome 13 and cover 15 forming the interior surface(s) of the cavity 11 are reflective; and at least one inner surface, typically that of the dome, is diffusely reflective. One or more apertures 17, in this example formed through the plate 15, provide a light passage for transmission of reflected and integrated light outward from the cavity 11. Materials, possible shapes, positions and orientations for the elements 11 to 17 have been discussed above. As in the earlier examples, the system 260 includes a number of LEDs 19 emitting light of different wavelengths into the cavity 11, although other solid state light emitting elements may be used. The possible combinations and positions of the LEDs 19 have been discussed in detail above, in relation to the earlier examples.

The LEDs 19 emit light of multiple colors into the interior of the optical integrating cavity 11. In this example, the light colors are in the visible portion of the radiant energy spectrum. Control of the amplitudes of the drive currents applied to the LEDs 19 controls the amount of each light color supplied into the cavity 11. A number of the LEDs will be active, from initial start-up, whereas others may initially be inactive ‘sleepers,’ as discussed above. The cavity 11 combines the various amounts of light of the different colors into a uniform light of a desired color temperature for emission through the aperture 17. The aperture 17 exhibits characteristics of a virtual source as discussed above, however, because of further processing, an observer may not see the aperture 17 as the virtual source of the system 260, as will be discussed later.

The system 260 also includes a control circuit 262 coupled to the LEDs 19 for establishing output intensity of radiant energy of each of the LED sources. The control circuit 262 typically includes a power supply circuit coupled to a source, shown as an AC power source 264, although the power source 264 may be a DC power source. In either case, the circuit 262 may be adapted to process the voltage from the available source to produce the drive currents necessary for the LEDs 19. The control circuit 262 includes an appropriate number of LED driver circuits, as discussed above relative to FIGS. 10 and 11, for controlling the power applied to each of the individual LEDs 19 and thus the intensity of radiant energy supplied to the cavity 11 for each different type/color of light. Control of the intensity of emission of each of the LED sources sets a spectral characteristic of the uniform combined light energy emitted through the aperture 17 of the optical integrating cavity 11, in this case, the color characteristic(s) of the visible light output.

The control circuit 262 may respond to a number of different control input signals, for example, to one or more user inputs as shown by the arrow in FIG. 16. Feedback may also be provided by a temperature sensor (not shown in this example) or one or more color sensors 266. The color sensor(s) 266 may be located in the cavity or in the element or elements for processing light emitted through the aperture 17. However, in many cases, the plate 15 and/or dome 13 may pass some of the integrated light from the cavity, in which case, it is actually sufficient to place the color light sensor(s) 266 adjacent any such transmissive point on the outer wall that forms the cavity. In the example, the sensor 266 is shown attached to the plate 15. Details of the control feedback have been discussed earlier, with regard to the circuitry in FIG. 10.

The example of FIG. 16 utilizes a different arrangement for directing and processing the light after emission from the cavity 11 through the aperture 17. This system 260 utilizes a collimator 253, an adjustable iris 255 and an adjustable focus lens system 259.

The collimator 253 may have a variety of different shapes, depending on the desired application and the attendant shape of the aperture 17. For ease of discussion here, it is assumed that the elements shown are circular, including the aperture 17. Hence, in the example, the collimator 253 comprises a substantially cylindrical tube, having a circular opening at a proximal end coupled to the aperture 17 of the optical integrating cavity 11. The system 260 emits light toward a desired field of illumination via the circular opening at the distal end of the collimator 253.

The interior surface of the collimator 253 is reflective. The reflective inner surface may be diffusely reflective or quasi-specular. Typically, in this embodiment, the interior surface of the deflector/collimator element 253 is specular. The tube forming the collimator 253 also supports a series of elements for optically processing the collimated and integrated light. Those skilled in the art will be familiar with the types of processing elements that may be used, but for purposes of understanding, it may be helpful to consider two specific types of such elements.

First, the tube forming the collimator 253 supports a variable iris. The iris 257 represents a secondary aperture, which effectively limits the output opening and thus the intensity of light that may be output by the system 260. Although shown in the collimator tube, the iris may be mounted in or serve as the aperture 17. A circuit 257 controls the size or adjustment of the opening of the iris 255. In practice, the user activates the LED control circuit (see e.g. 21 in FIG. 2) to set the color balance or temperature of the output light, that is to say, so that the system 260 outputs light of a desired color. The overall intensity of the output light is then controlled through the circuit 257 and the iris 255. Opening the iris 255 wider provides higher output intensity, whereas reducing the iris opening size decreases intensity of the light output.

In the system 260, the tube forming the collimator 253 also supports one or more lens elements of the adjustable focusing system 259, shown by way of example as two lenses 261 and 263. Spacing between the lenses and/or other parameters of the lens system 259 is adjusted by a mechanism 265, in response to a signal from a focus control circuit 267. The elements 261 to 267 of the system 259 are shown here by way of example, to represent a broad class of elements that may be used to variably focus the emitted light in response to a control signal or digital control information or the like. If the system 260 serves as a spot light, adjustment of the lens system 259 effectively controls the size of the spot on the target object or subject that the system illuminates. Those skilled in the art will recognize that other optical processing elements may be provided, such as a mask to control the shape of the illumination spot or various shutter arrangements for beam shaping.

Although shown as separate control circuits 257 and 267, the functions of these circuits may be integrated together with each other or integrated into the circuit 262 that controls the operation of the LEDs 19. For example, the system might use a single microprocessor or similar programmable microcontroller, which would run control programs for the LED drive currents, the iris control and the focus control.

The optical integrating cavity 11 and the LEDs 19 produce light of a precisely controlled composite color. As noted, control of the LED currents controls the amount of each color of light integrated into the output and thus the output light color. Control of the opening provided by the iris 255 then controls the intensity of the integrated light output of the system 260. Control of the focusing by the system 259 enables control of the breadth of the light emissions and thus the spread of the area or region to be illuminated by the system 260. The light distribution across each aperture is uniform. The outermost visible aperture limitation, as reduced or magnified by the lens system, appears as the virtual source output of the system 260. Assuming, diameter of iris 255 is set smaller than the diameter of aperture 17, the iris opening would form the virtual source. However, the adjustment of lens system 259 may reduce or enlarge the effective area of that light source. Other elements may be provided to control beam shape. Professional production lighting applications for such a system include theater or studio lighting, for example, where it is desirable to control the color, intensity and the size of a spotlight beam. By connecting the LED control circuit 257, the iris control circuit 257 and the focus control circuit 267 to a network similar to that in FIG. 12, it becomes possible to control color, intensity and spot size from a remote network terminal, for example, at an engineer's station in the studio or theater.

The discussion of the examples above has mainly referenced illuminance type lighting applications, for example to illuminate rooms for task lighting on other general illumination or provide spot lighting in a theater or studio. Only brief mention has been given so far, of other applications. Those skilled in the art will recognize, however, that the principles discussed herein may also find wide use in other lighting applications, particularly in luminance applications, such as various kinds of signal lighting and/or signage.

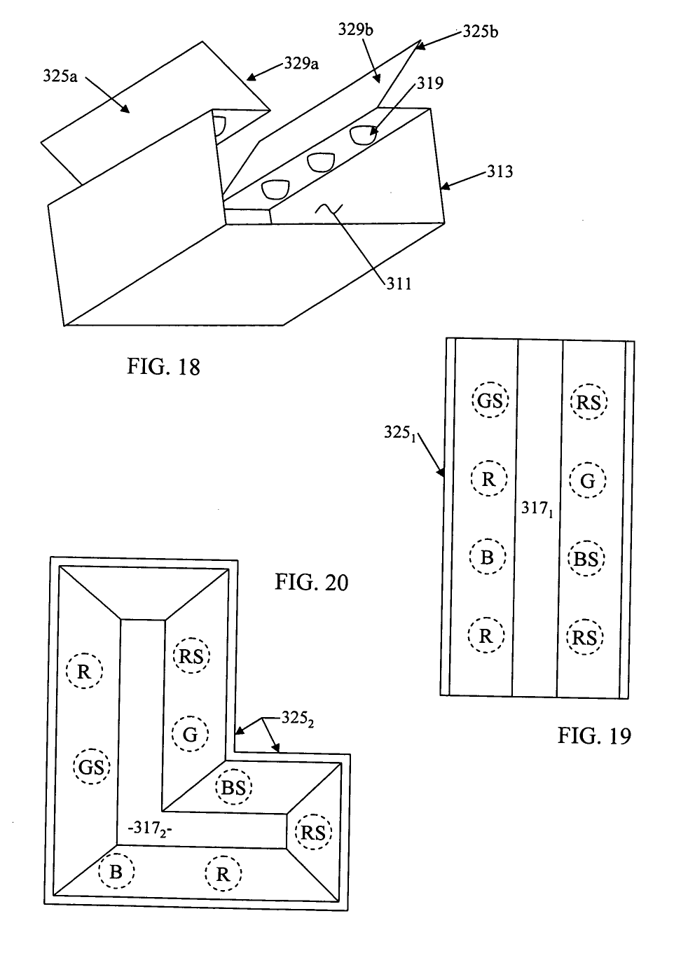

FIG. 17 is a cross-sectional view of another example of an optical cavity type fixture utilizing solid state light emitting elements. Although this design may be used for illumination, for purposes of discussion here, we will concentrate on application for luminance purposes. The fixture 300 includes an optical cavity 311 having a diffusely reflective inner surface, as in the earlier examples. In this fixture, the cavity 311 has a substantially rectangular cross-section. FIG. 18 is an isometric view of a portion of a fixture having the cross-section of FIG. 17, showing several of the dome and plate components formed as a single extrusion of the desired cross section. FIGS. 19 and 20 then show use of such a fixture arranged so as to construct lighted letters.

The fixture 300 preferably includes several initially-active LEDs and several sleeper LEDs, generally shown at 319, similar to those in the earlier examples. The LEDs emit controlled amounts of multiple colors of light into the optical integrating cavity 311 formed by the inner surfaces of a rectangular member 313. A power source and control circuit similar to those used in the earlier examples provide the drive currents for the LEDs 319, and in view of the similarity, the power source and control circuit are omitted from FIG. 17, to simplify the illustration. One or more apertures 317, of the shape desired to facilitate the particular luminance application, provide light passage for transmission of reflected and integrated light outward from the cavity 311. Materials for construction of the cavity and the types of LEDs that may be used are similar to those discussed relative to the earlier illumination examples, although the number and intensities of the LEDs may be different, to achieve the output parameters desired for the particular luminance application. Again, the light output through the aperture is relatively uniform and unpixelated. Depending on the configuration of the deflector and/or further optical processing, the aperture 317 may form the virtual source for the light output of the system.

The fixture 300 in this example (FIG. 17) includes a deflector 325 to further process and direct the light emitted from the aperture 317 of the optical integrating cavity 311. The deflector 325 has a reflective interior surface 329 and expands outward laterally from the aperture, as it extends away from the cavity toward the region to be illuminated. In a circular implementation, the deflector 325 would be conical. However, in the example of FIG. 18, the deflector is formed by two opposing panels 325a and 325b of the extruded body. The surfaces 329a and 329b of the panels are reflective. As in the earlier examples, all or portions of the deflector surfaces may be diffusely reflective, quasi-specular or specular. For some examples, it may be desirable to have one panel surface 329a diffusely reflective and have specular reflectivity on the other panel surface 329b.

As shown in FIG. 17, a small opening at a proximal end of the deflector 325 is coupled to the aperture 317 of the optical integrating cavity 311. The deflector 325 has a larger opening at a distal end thereof. The angle of the interior surface 329 and size of the distal opening of the deflector 325 define an angular field of radiant energy emission from the apparatus 300. The large opening of the deflector 325 is covered with a grating, a plate or the exemplary lens 331 (which is omitted from FIG. 18, for convenience). The lens 331 may be clear or translucent to provide a diffuse transmissive processing of the light passing out of the large opening. Prismatic materials, such as a sheet of microprism plastic or glass also may be used. If the further processing by the deflector 325 and lens 331 are sufficiently diffuse, the distal deflector opening and/or the lens will appear as the virtual source of light output from the system.

The overall shape of the fixture 300 may be chosen to provide a desired luminous shape, for example, in the shape of any selected number, character, letter, or other symbol. FIG. 19, for example, shows a view of such a fixture, as if looking back from the area receiving the light, with the lens removed from the output opening of the deflector. In this example, the aperture 317₁ and the output opening of the deflector 325₁ are both rectangular, although they may have somewhat rounded corners. Alternatively, the deflector may be somewhat oval in shape. To the observer, the fixture will appear as a tall rectangular light. If the long dimension of the rectangular shape is extended or elongated sufficiently, the lighted fixture might appear as a lighted letter I. The shapes of the cavity and the aperture may vary, for example, to have rounded ends, and the deflector may be contoured to match the aperture, for example, to provide softer or sharper edges and/or to create a desired font style for the letter.

FIG. 20 shows a view of another example such a fixture, again as if looking back from the area receiving the light with the lens removed from the output opening of the deflector. In this example, the aperture 317₂ and the output opening of the deflector 325₂ are both L-shaped. When lighted, the observer will perceive the fixture as a lighted letter L. Of course, the shapes of the aperture and deflector openings may vary somewhat, for example, by using curves or rounded corners, so the letter approximates the shape for a different type font.

The extruded body construction illustrated in FIG. 18 may be curved or bent for use in different letters. By combining several versions of the fixture 300, shaped to represent different letters, it becomes possible to spell out words and phrases. Control of the amplitudes of the drive currents applied to the LEDs 319 of each fixture controls the amount of each light color supplied into the respective optical integrating cavity and thus the combined light output color of each number, character, letter, or other symbol.

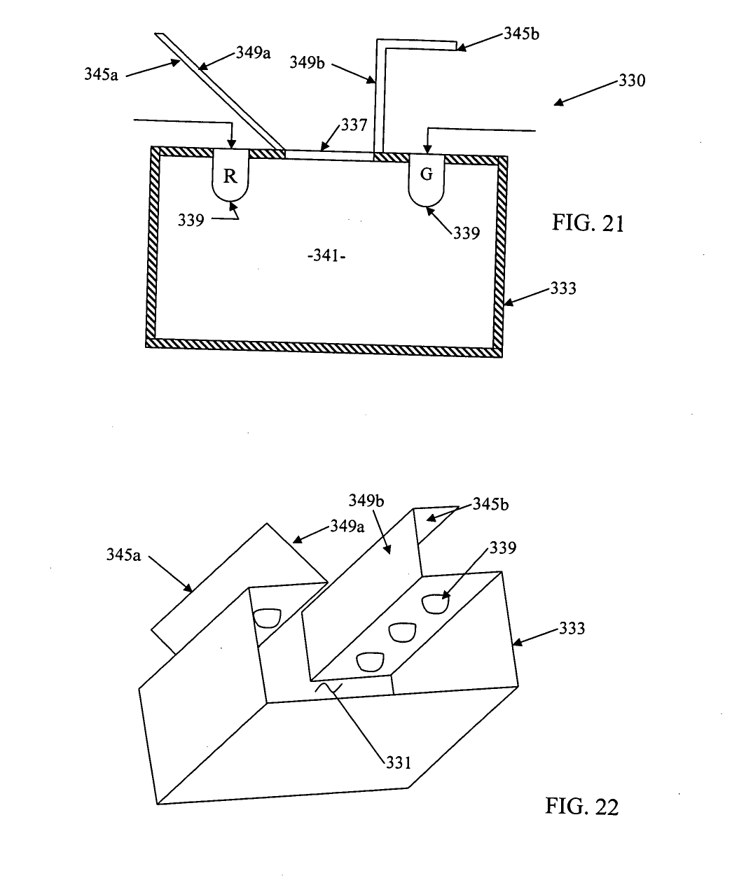

FIGS. 21 and 22 show another virtual source light fixture, but here adapted for use as a “wall-washer” illuminant lighting fixture. The fixture 330 includes an optical integrating cavity 331 having a diffusely reflective inner surface, as in the earlier examples. In this fixture, the cavity 331 again has a substantially rectangular cross-section. FIG. 22 is an isometric view of a section of the fixture, showing several of the components formed as a single extrusion of the desired cross section, but without any end-caps. Again, the light output through the aperture is relatively uniform and unpixelated and may form the virtual source output.

As shown in these figures, the fixture 330 includes several initially-active LEDs and several sleeper LEDs, generally shown at 339, similar to those in the earlier examples. The LEDs emit controlled amounts of multiple colors of light into the optical integrating cavity 341 formed by the inner surfaces of a rectangular member 333. A power source and control circuit similar to those used in the earlier examples provide the drive currents for the LEDs 339, and in view of the similarity, the power source and control circuit are omitted from FIG. 21, to simplify the illustration. One or more apertures 337, of the shape desired to facilitate the particular lighting application, provide light passage for transmission of reflected and integrated light outward from the cavity 341. Materials for construction of the cavity and the types of LEDs that may be used are similar to those discussed relative to the earlier illumination examples, although the number and intensities of the LEDs may be different, to achieve the virtual source output parameters desired for the particular wall-washer application.

The fixture 330 in this example (FIG. 21) includes a deflector to further process and direct the light emitted from the aperture 337 of the optical integrating cavity 341, in this case toward a wall, product or other subject somewhat to the left of and above the fixture 330. The deflector is formed by two opposing panels 345a and 345b of the extruded body of the fixture. The panel 345a is relatively flat and angled somewhat to the left, in the illustrated orientation. Assuming a vertical orientation of the fixture as shown in FIG. 21, the panel 345b extends vertically upward from the edge of the aperture 337 and is bent back at about 90°. The shapes and angles of the panels 345a and 345b are chosen to direct the light to a particular area of a wall or product display that is to be illuminated, and may vary from application to application.

Each panel 345a, 345b has a reflective interior surface 349a, 349b. As in the earlier examples, all or portions of the deflector surfaces may be diffusely reflective, quasi-specular or specular. In the wall washer example, the deflector panel surface 349b is diffusely reflective, and the deflector panel surface 349a has a specular reflectivity, to optimize distribution of emitted light over the desired area illuminated by the fixture 330.

The output opening of the deflector 345 may be covered with a grating, a plate or lens, in a manner similar to the example of FIG. 17, although in the illustrated wall washer example, such an element is omitted.

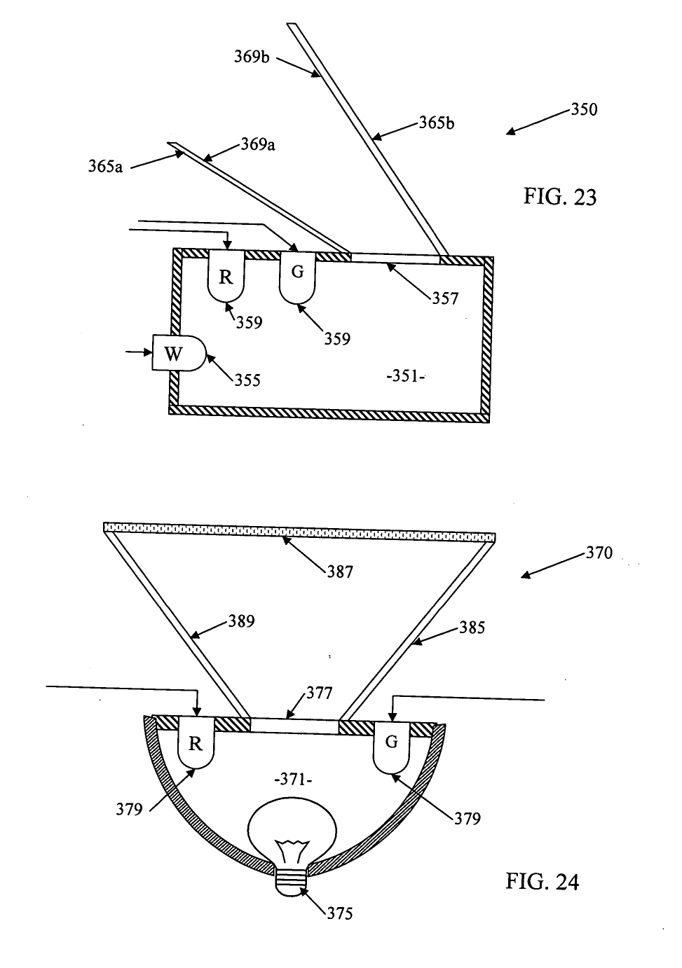

FIG. 23 is a cross sectional view of another example of a wall washer type fixture 350. The fixture 350 includes an optical integrating cavity 351 having a diffusely reflective inner surface, as in the earlier examples. In this fixture, the cavity 351 again has a substantially rectangular cross-section. As shown, the fixture 350 includes at least one white light source, represented by the white LED 355. The fixture also includes several LEDs 359 of the various primary colors, typically red (R), green (G) and blue (B, not visible in this cross-sectional view). The LEDs 359 include both initially-active LEDs and sleeper LEDs, and the LEDs 359 are similar to those in the earlier examples. Although various white LEDs or single color LEDs may be used, in this example, the LEDs emit controlled amounts of multiple colors of light into the optical integrating cavity 351 formed by the inner surfaces of a rectangular member 353. A power source and control circuit similar to those used in the earlier examples provide the drive currents for the LEDs 359, and in this example, that same circuit controls the drive current applied to the white LED 355. In view of the similarity, the power source and control circuit are omitted from FIG. 23, to simplify the illustration.

One or more apertures 357, of the shape desired to facilitate the particular lighting application, provide light passage for transmission of reflected and integrated light outward from the cavity 351. The aperture may be laterally centered, as in the earlier examples; however, in this example, the aperture is off-center to facilitate a light-throw to the left (in the illustrated orientation). Materials for construction of the cavity and the types of LEDs that may be used are similar to those discussed relative to the earlier illumination examples. Again, the virtual source light output through the aperture is relatively uniform and unpixelated.

Here, it is assumed that the fixture 350 is intended to principally provide a virtual source of white light, for example, to illuminate a wall or product to the left and somewhat above the fixture. The presence of the white light source 355 increases the intensity of white light that the fixture produces. The control of the outputs of the primary color LEDs 359 allows the operator to correct for any variations of the white light from the source 355 from normal white light and/or to adjust the color balance/temperature of the light output. For example, if the white light source 355 is an LED as shown, the white light it provides tends to be rather blue. The intensities of light output from the LEDs 359 can be adjusted to compensate for this blueness, for example, to provide a light output approximating sunlight or light from a common incandescent source, as or when desired.

As another example of operation, the fixture 350 may be used to illuminate products, e.g. as displayed in a store or the like, although it may be rotated or inverted for such a use. Different products may present a better impression if illuminated by white light having a different balance. For example, fresh bananas may be more attractive to a potential customer when illuminated by light having more yellow tones. Soda sold in red cans, however, may be more attractive to a potential customer when illuminated by light having more red tones. For each product, the user can adjust the intensities of the light outputs from the LEDs 359 and/or 355 to produce light that appears substantially white if observed directly by a human/customer but provides the desired highlighting tones and thereby optimizes lighting of the particular product that is on display.

The fixture 350 may have any desired output processing element(s), as discussed above with regard to various earlier examples. In the illustrated wall washer embodiment (FIG. 23), the fixture 350 includes a deflector to further process and direct the light emitted from the aperture 357 of the optical integrating cavity 351, in this case toward a wall or product somewhat to the left of and above the fixture 350. The deflector is formed by two opposing panels 365a and 365b having reflective inner surfaces 365a and 365b. Although other shapes may be used to direct the light output to the desired area or region, the illustration shows the panel 365a, 365b as relatively flat panels set at somewhat different angle extending to the left, in the illustrated orientation. Of course, as for all the examples, the fixture may be turned at any desired angle or orientation to direct the light to a particular region or object to be illuminated by the fixture, in a given application.

As noted, each panel 365a, 365b has a reflective interior surface 369a, 369b. As in the earlier examples, all or portions of the deflector surfaces may be diffusely reflective, quasi-specular or specular. In the wall washer example, the deflector panel surface 369b is diffusely reflective, and the deflector panel surface 369a has a specular reflectivity, to optimize distribution of emitted light over the desired area of the wall illuminated by the fixture 350. The output opening of the deflector 365 may be covered with a grating, a plate or lens, in a manner similar to the example of FIG. 17, although in the illustrated wall washer example, such an element is omitted.

FIG. 24 is a cross-sectional view of another example of a virtual source type light fixture 370 using an optical integrating cavity. This example uses a deflector and lens to optically process the light output, and like the example of FIG. 23 the fixture 370 includes LEDs to produce various colors of light in combination with a white light source. The fixture 370 includes an optical integrating cavity 371, formed by a dome and a cover plate, although other structures may be used to form the cavity. The surfaces of the dome and cover forming the interior surface(s) of the cavity 371 are diffusely reflective. One or more apertures 377, in this example formed through the cover plate, provide a light passage for transmission of reflected and integrated light outward from the cavity 371. Materials, sizes, orientation, positions and possible shapes for the elements forming the cavity and the types/numbers of solid state light emitters have been discussed above. Again, the virtual source light output through the aperture is relatively uniform and unpixelated.

As shown, the fixture 370 includes at least one white light source. Although the white light source could comprise one or more LEDs, as in the previous example (FIG. 23), in this embodiment, the white light source comprises a lamp 375. The lamp may be any convenient form of light bulb, such as an incandescent or fluorescent light bulb; and there may be one, two or more bulbs to produce a desired amount of white light. A preferred example of the lamp 375 is a quartz halogen light bulb. The fixture also includes several LEDs 379 of the various primary colors, typically red (R), green (G) and blue (B, not visible in this cross-sectional view), although additional colors may be provided or other color LEDs may be substituted for the RGB LEDs. Some LEDs will be active from initial operation. Other LEDs may be held in reserve as sleepers. The LEDs 379 are similar to those in earlier examples, for emitting controlled amounts of multiple colors of light into the optical integrating cavity 371.

A power source and control circuit similar to those used in the earlier examples provide the drive currents for the LEDs 359. In view of the similarity, the power source and control circuit for the LEDs are omitted from FIG. 24, to simplify the illustration. The lamp 375 may be controlled by the same or similar circuitry, or the lamp may have a fixed power source.

The white light source 375 may be positioned at a point that is not directly visible through the aperture 377 similar to the positions of the LEDs 379. However, for applications requiring relatively high white light output intensity, it may be preferable to position the white light source 375 to emit a substantial portion of its light output directly through the aperture 377.

The fixture 370 may incorporate any of the further optical processing elements discussed above. For example, the fixture may include a variable iris and variable focus system, as in the embodiment of FIG. 16. In the illustrated version, however, the fixture 370 includes a deflector 385 to further process and direct the light emitted from the aperture 377 of the optical integrating cavity 371. The deflector 385 has a reflective interior surface 389-and expands outward laterally from the aperture, as it extends away from the cavity toward the region to be illuminated. In a circular implementation, the deflector 385 would be conical. Of course, for applications using other fixture shapes, the deflector may be formed by two or more panels of desired sizes and shapes. The interior surface 389 of the deflector 385 is reflective. As in the earlier examples, all or portions of the reflective deflector surface(s) may be diffusely reflective, quasi-specular, specular or combinations thereof.

As shown in FIG. 24, a small opening at a proximal end of the deflector 385 is coupled to the virtual source at aperture 377 of the optical integrating cavity 311. The deflector 385 has a larger opening at a distal end thereof. The angle of the interior surface 389 and size of the distal opening of the deflector 385 define an angular field of radiant energy emission from the apparatus 370.

The large opening of the deflector 385 is covered with a grating, a plate or the exemplary lens 387. The lens 387 may be clear or translucent to provide a diffuse transmissive processing of the light passing out of the large opening. Prismatic materials, such as a sheet of microprism plastic or glass also may be used. In applications where a person may look directly at the fixture 370 from the illuminated region, it is preferable to use a translucent material for the lens 387, to shield the observer from directly viewing the lamp 375. If sufficiently diffuse, the lens 387 may form the virtual source that is observable from the region illuminated by the fixture.

The fixture 370 thus includes a deflector 385 and lens 387, for optical processing of the integrated light emerging from the cavity 371 via the aperture 377. Of course, other optical processing elements may be used in place of or in combination with the deflector 385 and/or the lens 387, such as those discussed above relative to FIGS. 15A to 15C and 16.

In the fixture of FIG. 24, the lamp 375 provides substantially white light of relatively high intensity. The integration of the light from the LEDs 379 in the cavity 375 supplements the light from the lamp 375 with additional colors, and the amounts of the different colors of light from the LEDs can be precisely controlled. Control of the light added from the LEDs can provide color correction and/or adjustment, as discussed above relative to the embodiment of FIG. 23.

As shown by the discussion above, each of the various radiant energy emission systems with multiple color sources and an optical cavity to combine the energy from the sources provides a highly effective means to control the color produced by one or more fixtures. The output color characteristics are controlled simply by controlling the intensity of each of the sources supplying radiant energy to the chamber.

Settings for a desirable color are easily reused or transferred from one system/fixture to another. If color/temperature/balance offered by particular settings are found desirable, e.g. to light a particular product on display or to illuminate a particular person in a studio or theater, it is a simple matter to record those settings and apply them at a later time. Similarly, such settings may be readily applied to another system or fixture, e.g. if the product is displayed at another location or if the person is appearing in a different studio or theater. It may be helpful to consider the product and person lighting examples in somewhat more detail.

For the product, assume that a company will offer a new soft drink in a can having a substantial amount of red product markings. The company can test the product under lighting using one or more fixtures as described herein, to determine the optimum color to achieve a desired brilliant display. In a typical case, the light will generally be white to the observer. In the case of the red product container, the white light will have a relatively high level of red, to make the red markings seem to glow when the product is viewed by the casual observer/customer. When the company determines the appropriate settings for the new product, it can distribute those settings to the stores that will display and sell the product. The stores will use other fixtures of any type disclosed herein. The fixtures in the stores need not be of the exact same type that the company used during product testing. Each store uses the settings received from the company to establish the spectral characteristic(s) of the lighting applied to the product by the store's fixture(s), in our example, so that each product display provides the desired brilliant red illumination of the company's new soft drink product.

Consider now a studio lighting example for an actor or newscaster. The person is tested under lighting using one or more fixtures as described herein, to determine the optimum color to achieve desired appearance in video or film photography of the individual. Again, the light will generally be white to the observer, but each person will appear better at somewhat different temperature or color balance levels. One person might appear more healthy and natural under warmer light, whereas another might appear better under bluer/colder white light. After testing to determine the person's best light color settings, the settings are recorded. Each time the person appears under any lighting using the systems disclosed herein, in the same or a different studio, the technicians operating the lights can use the same settings to control the lighting and light the person with light of exactly the same spectral characteristic(s). Similar processes may be used to define a plurality of desirable lighting conditions for the actor or newscaster, for example, for illumination for different moods or different purposes of the individual's performances.

The methods for defining and transferring set conditions, e.g. for product lighting or personal lighting, can utilize manual recordings of settings and input of the settings to the different lighting systems. However, it is preferred to utilize digital control, in systems such as described above relative to FIGS. 10 and 12. Once input to a given lighting system, a particular set of parameters for a product or individual become another ‘preset’ lighting recipe stored in digital memory, which can be quickly and easily recalled and used each time that the particular product or person is to be illuminated.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A solid state light fixture, comprising:
a solid state light emitting element, for emitting a point source output of light comprising humanly visible electromagnetic energy;
an optical output; and
an optical processing element coupled between the solid state light emitting element and the optical output, for receiving the point source output of light from the solid state light emitting element and converting the received light for output as a virtual source at the optical output.

2. The solid state light fixture of claim 1, wherein the optical processing element produces a substantially uniform distribution of the light output across an area of the virtual source.

3. The solid state light fixture of claim 2, wherein the distribution is substantially Lambertian.

4. The solid state light fixture of claim 2, wherein the distribution is unpixelated.

5. The solid state light fixture of claim 2, wherein the distribution of light across the area of the virtual source exhibits a maximum-to-minimum ratio of 2:1 or less.

6. The solid state light fixture of claim 1, wherein area of the virtual source is at least one order of magnitude larger than area of the point source output of light emitted from the solid state light emitting element.

7. The solid state light fixture of claim 1, wherein the solid state light emitting element is for emitting visible white light.

8. The solid state light fixture of claim 1, wherein the solid state light emitting element is for emitting visible light of a primary color.

9. The solid state light fixture of claim 1, wherein the solid state light emitting element comprises a light emitting diode.

10. The solid state light fixture of claim 1, wherein the optical processing element comprises:
an optical integrating cavity having a reflective interior surface, at least a portion of which exhibits a diffuse reflectivity, the optical integrating cavity being coupled for receiving the light from the solid state light emitting element as a point source for diff-use reflection within the optical integrating cavity; and
an optical aperture for allowing emission of processed light from within the optical integrating cavity.

11. The solid state light fixture of claim 10, wherein the diffuse reflection within the optical integrating cavity produces the virtual source at the optical aperture.

12. The solid state light fixture of claim 11, wherein:
the solid state light emitting element is coupled to emit light into the optical integrating cavity from a location on a wall of the optical integrating cavity; and
the location on the wall of the optical integrating cavity is such that substantially all light emissions from the solid state light emitting element reflect at least once within the optical integrating cavity before emission via the virtual source produced at the optical aperture.

13. The solid state light fixture of claim 12, wherein diffuse reflection within the optical integrating cavity produces a substantially uniform intensity distribution across the entire optical aperture.

14. The solid state light fixture of claim 13, wherein the intensity distribution across the entire optical aperture is substantially Lambertian.

15. The solid state light fixture of claim 13, wherein the intensity distribution across the entire optical aperture is unpixelated.

16. The solid state light fixture of claim 13, wherein the intensity distribution across the entire optical aperture exhibits a maximum-to-minimum ratio of 2:1 or less.

17. The solid state light fixture of claim 10, wherein area of the optical aperture is substantially larger than area of the point source output of light emitted from the solid state light emitting element.

18. The solid state light fixture of claim 10, wherein the optical integrating cavity comprises:
a dome having a reflective surface; and
a plate having a substantially reflective surface facing the reflective surface of the dome, coupled to the dome so as to form the optical integrating cavity between the reflective surfaces of the dome and plate, at least a portion of one of the reflective surfaces of the dome and plate being diffusely reflective.

19. The solid state light fixture of claim 18, wherein the optical aperture comprises a light transmissive passage through the plate.

20. The solid state light fixture of claim 18, wherein the dome is configured such that the portion of the reflective interior surface of the optical integrating cavity formed by the dome has a contour corresponding to a segment of a sphere.

21. The solid state light fixture of claim 20, wherein the contour is substantially hemispherical.

22. The solid state light fixture of claim 18, wherein the dome is configured such that the portion of the reflective interior surface of the optical integrating cavity formed by the dome has a contour corresponding to a segment of a cylinder.

23. The solid state light fixture of claim 22, wherein the contour is substantially semi-cylindrical contour.

24. The solid state light fixture of claim 18, wherein the dome and plate are configured such that the interior surface of the optical integrating cavity has a substantially rectangular cross-section.

25. A lighting system comprising: the solid state light fixture of claim 1 in combination with a controller for controlling operation of the solid state light emitting element and a user interface device for providing an input to the controller.

26. The lighting system of claim 25, further comprising a sensor for detecting a characteristic of light from the optical processing element and providing a feedback control signal to the controller.

27. The lighting system of claim 26, wherein:
the solid state light emitting element comprises a plurality of solid state light emitting elements;
a first one of the plurality of solid state light emitting elements is initially active;
a second one of the plurality of solid state light emitting elements is a redundant element that may be activated on an as needed basis; and
the controller activates the redundant second solid state light emitting element upon detection of a decline in performance of the first solid state lighting element in response to the feedback control signal from the sensor.

28. A solid state light fixture, comprising:
a solid state light emitting element, for emitting a point source output of visible light; and
means for converting the point source output of light from the solid state light emitting element to a virtual source output of the solid state light fixture,
wherein area of the virtual source is at least one order of magnitude larger than area of the point source output of light from the solid state light emitting element.

29. The solid state light fixture of claim 28, wherein the means for converting produces a substantially uniform light output distribution across the area of the virtual source.

30. The solid state light fixture of claim 29, wherein the distribution is substantially Lambertian.

31. The solid state light fixture of claim 29, wherein the distribution is unpixelated.

32. The solid state light fixture of claim 29, wherein the distribution exhibits a maximum-to-minimum ratio of 2:1 or less across the area of the virtual source.

33. The solid state light fixture of claim 28, wherein the solid state light emitting element is for emitting visible white light.

34. The solid state light fixture of claim 28, wherein the solid state light emitting element is for emitting visible light of a primary color.

35. The solid state light fixture of claim 28, wherein the solid state light emitting element comprises a light emitting diode.

36. The solid state light fixture of claim 30, wherein said means for converting comprises:
an optical integrating cavity having a reflective interior surface, at least a portion of which exhibits a diffuse reflectivity, the optical integrating cavity being coupled for receiving the light from the solid state light emitting element as a point source for diffuse reflection within the optical integrating cavity; and
an optical aperture for allowing emission of diffusely reflected light from within the optical integrating cavity.

37. The solid state light fixture of claim 36, wherein the diffuse reflection within the optical integrating cavity produces the virtual source at the optical aperture.

38. The solid state light fixture of claim 37, wherein:
the solid state light emitting element is coupled to emit light into the optical integrating cavity from a location on a wall of the optical integrating cavity; and
the location on the wall of the optical integrating cavity is such that substantially all light emissions from the solid state light emitting element reflect at least once within the optical integrating cavity before emission via the virtual source produced at the optical aperture.

39. The solid state light fixture of claim 38, wherein the diffuse reflection within the optical integrating cavity produces a substantially uniform intensity distribution across the entire optical aperture.

40. The solid state light fixture of claim 39, wherein the intensity distribution across the entire optical aperture is substantially Lambertian.

41. The solid state light fixture of claim 39, wherein the intensity distribution across the entire optical aperture is unpixelated.

42. The solid state light fixture of claim 39, wherein the intensity distribution exhibits a maximum-to-minimum ratio of 2:1 or less across the entire optical aperture.

43. The solid state light fixture of claim 36, wherein the optical integrating cavity comprises:
a dome having a reflective surface; and
a plate having a substantially reflective surface facing the reflective surface of the dome, coupled to the dome so as to form the optical integrating cavity between the reflective surfaces of the dome and plate, at least a portion of one of the reflective surfaces of the dome and plate being diffusely reflective.

44. The solid state light fixture of claim 43, wherein the optical aperture comprises a light transmissive passage through the plate.

45. The solid state light fixture of claim 43, wherein the dome is configured such that the portion of the reflective interior surface of the optical integrating cavity formed by the dome has a contour corresponding to a segment of a sphere.

46. The solid state light fixture of claim 45, wherein the contour is substantially hemispherical.

47. The solid state light fixture of claim 43, wherein the dome is configured such that the portion of the reflective interior surface of the optical integrating cavity formed by the dome has a contour corresponding to a segment of a cylinder.

48. The solid state light fixture of claim 47, wherein the contour is substantially semi-cylindrical.

49. The solid state light fixture of claim 43, wherein the dome and plate are configured such that the optical integrating cavity has a substantially rectangular cross-section.

50. A lighting system comprising: the solid state light fixture of claim 28 in combination with a controller for controlling operation of the solid state light emitting elements and a user interface device for providing an input to the controller.

51. The lighting system of claim 50, further comprising a sensor for detecting a characteristic of the converted light and providing a feedback control signal to the controller.

52. The lighting system of claim 51, wherein:
the solid state light emitting element comprises a plurality of solid state light emitting elements;
a first one of the plurality of solid state light emitting elements is initially active;
a second one of the plurality of solid state light emitting elements is a redundant element that may be activated on an as needed basis; and
the controller activates the redundant second solid state light emitting element upon detection of a decline in performance of the first solid state lighting element in response to the feedback control signal from the sensor.

53. A solid state light source having a point source solid state light emitting element, the source being configured to produce a substantially uniform output of light from the solid state element at a virtual source output.

54. A method of outputting light from a virtual source, using a solid state light emitting element, the method comprising:
operating the solid state light emitting element to generate a point source of humanly visible light; and
converting the humanly visible light generated by the solid state light emitting element to a virtual source of light of an area at least one order of magnitude larger than an area of the point source.

55. The method of claim 54, wherein distribution of light from the virtual source is substantially uniform across the area of the virtual source.

56. The method of claim 55, wherein the distribution of light from the virtual source is substantially Lambertian.

57. The method of claim 55, wherein the distribution of light from the virtual source is unpixelated.

58. The method of claim 55, wherein the distribution of light from the virtual source exhibits a maximum-to-minimum ratio of 2:1 or less across the area of the virtual source.

59. A lighting system, comprising:
a solid state light emitting element, for emitting visible light;
a diffuse optical processing element coupled to the solid state light emitting element, for converting a point source of the visible light from the solid state light emitting element to a virtual source of visible light; and
a controller responsive to an input for controlling an amount of visible light supplied to the diffuse optical processing element by the solid state light emitting element to control a characteristic of light emitted from the virtual source.

60. The lighting system of claim 59, wherein the diffuse optical processing element produces a substantially uniform distribution of the light output across an area of the virtual source.

61. The lighting system of claim 60, wherein the distribution is substantially Lambertian.

62. The lighting system of claim 60, wherein the distribution is unpixelated.

63. The lighting system of claim 60, wherein the distribution of light across the area of the virtual source exhibits a maximum-to-minimum ratio of 2:1 or less.

64. The lighting system of claim 59, wherein the solid state light emitting element comprises a light emitting diode.

65. The lighting system of claim 59, further comprising another solid state light emitting element for emitting light, the other solid state light emitting element being coupled to supply light as a point source to the optical processing element.

66. The lighting system of claim 65, wherein the other solid state light emitting element emits visible light.

67. The lighting system of claim 65, wherein the other solid state light emitting element emits ultraviolet (UV) or infrared (IR) light.

68. The lighting system of claim 59, further comprising a deflector having a reflective interior surface coupled to the virtual source.

69. The lighting system of claim 59, further comprising at least one initially inactive other solid state light emitting element coupled for activation by the controller when needed.

70. The lighting system of claim 59, wherein the optical processing element comprises an optical integrating cavity having a reflective interior surface, at least a portion of which exhibits a diffuse reflectivity, and having an optical aperture for allowing emission of reflected light from within the interior of the optical integrating cavity into a region to facilitate a humanly perceptible lighting application for the system.

71. The lighting system of claim 70, wherein diffuse reflection within the optical integrating cavity produces the virtual source at the optical aperture.

72. The lighting system of claim 70, wherein distribution of diffusely reflected light emitted through the optical aperture is substantially uniform.

73. The lighting system of claim 72, wherein the distribution of the light emitted through the optical aperture is substantially Lambertian.

74. The lighting system of claim 72, wherein the light emitted through the aperture is unpixelated.

75. The lighting system of claim 72, wherein the distribution of the light emitted through the optical aperture exhibits a maximum-to-minimum ratio of 2:1 or less across the optical aperture.

76. The lighting system of claim 76, wherein the optical integrating cavity comprises:
a dome having a reflective surface; and
a plate having a substantially flat reflective surface facing the reflective surface of the dome, coupled to the dome so as to form the optical integrating cavity between the reflective surfaces of the dome and plate, at least a portion of one of the reflective surfaces of the dome and plate being diffusely reflective.

77. The lighting system of claim 76, wherein the optical aperture comprises a light transmissive passage through the plate.

78. The lighting system of claim 76, wherein the dome is configured such that the portion of the reflective interior surface of the optical integrating cavity formed by the dome has a contour corresponding to a segment of a sphere.

79. The lighting system of claim 78, wherein the contour is substantially hemispherical.

80. The lighting system of claim 76, wherein the dome is configured such that the portion of the reflective interior surface of the optical integrating cavity formed by the dome has a contour corresponding to a segment of a cylinder.

81. The lighting system of claim 80, wherein the contour is substantially semi-cylindrical.

82. The lighting system of claim 76, wherein the dome and plate are configured such that the interior surface of the optical integrating cavity has a substantially rectangular cross-section.

83. A solid state light fixture, comprising:
a plurality of solid state light emitting elements, each solid state light emitting element for emitting a point source output of light;
an optical output; and
an optical processing element coupled between the solid state light emitting elements and the optical output, for receiving the point source outputs of light from the solid state light emitting elements and converting the received light to a combined virtual source for emission via the optical output.

84. The solid state light fixture of claim 83, wherein the optical processing element produces a substantially uniform distribution across an area of the virtual source at the optical output of the solid state light fixture.

85. The solid state light fixture of claim 84, wherein the distribution is substantially Lambertian.

86. The solid state light fixture of claim 84, wherein the distribution is unpixelated.

87. The solid state light fixture of claim 84, wherein the distribution of light across the area of the virtual source exhibits a maximum-to-minimum ratio of 2:1 or less.

88. The solid state light fixture of claim 83, wherein area of the virtual source output of the solid state light fixture is substantially larger than combined area of the point source outputs of light from the solid state light emitting elements.

89. The solid state light fixture of claim 83, wherein:
a first one of the solid state light emitting elements is for emitting visible light of a first color; and
a second one of the solid state light emitting elements is for emitting visible light of a second color different from the first color.

90. The solid state light fixture of claim 89, wherein:
the first one of the solid state light emitting elements is for emitting visible white light; and
the second one of the solid state light emitting elements is for emitting a specific color of visible light; and
combination of the white light and the specific color light by the optical element changes color temperature of the white light before emission of combined light from the virtual source.

91. The solid state light fixture of claim 89, wherein:
the first one of the solid state light emitting elements is for emitting visible white light of a first color temperature; and
the second one of the solid state light emitting elements is for emitting visible white light of a second color temperature different from the first color temperature.

92. The solid state light fixture of claim 89, further comprising a third one of the solid state light emitting element for emitting visible light of a third color different from the first and second colors.

93. The solid state light fixture of claim 92, wherein the first, second and third solid state light emitting elements emit three different primary colors of visible light.

94. The solid state light fixture of claim 83, wherein the solid state light emitting elements are for emitting visible white light of substantially the same color temperature.

95. The solid state light fixture of claim 83, wherein:
a first one of the solid state light emitting elements is for emitting visible light; and
a second one of the solid state light emitting elements is for emitting ultraviolet (UV) or infrared (IR) light.

96. The solid state light fixture of claim 83, wherein the optical processing element comprises:
an optical integrating cavity having a reflective interior surface, at least a portion of which exhibits a diff-use reflectivity, the optical integrating cavity being coupled for receiving the light from the solid state light emitting elements for diffuse reflection within the optical integrating cavity; and
an optical aperture for allowing emission of combined light from within the interior of the optical integrating cavity.

97. The solid state light fixture of claim 96, wherein the diffuse reflection within the optical integrating cavity produces the virtual source at the optical aperture.

98. The solid state light fixture of claim 97, wherein:
each of the solid state light emitting elements is coupled to emit light into the optical integrating cavity from a location on a wall of the optical integrating cavity; and
the locations on the wall of the optical integrating cavity cause substantially all light emissions from the solid state light emitting elements to reflect at least once within the optical integrating cavity before emission from the virtual source produced at the optical aperture.

99. The solid state light fixture of claim 98, wherein the optical processing element produces a substantially uniform intensity distribution across an area of the optical aperture.

100. The solid state light fixture of claim 99, wherein the intensity distribution is substantially Lambertian.

101. The solid state light fixture of claim 99, wherein the intensity distribution is unpixelated.

102. The solid state light fixture of claim 99, wherein the intensity distribution exhibits a maximum-to-minimum ratio of 2:1 or less across the area of the optical aperture.

103. The solid state light fixture of claim 96, wherein area of the optical aperture is substantially larger than combined area of the point source outputs of light supplied to the optical integrating cavity from the solid state light emitting elements.

104. The solid state light fixture of claim 96, wherein the optical integrating cavity comprises:
a dome having a reflective surface; and
a plate having a substantially reflective surface facing the reflective surface of the dome, coupled to the dome so as to form the optical integrating cavity between the reflective surfaces of the dome and plate,
at least a portion of one of the reflective surfaces of the dome and plate being diffusely reflective.

105. The solid state light fixture of claim 104, wherein the optical aperture comprises a transmissive passage through the plate.

106. The solid state light fixture of claim 104, wherein the dome is configured such that the portion of the reflective interior surface of the optical integrating cavity formed by the dome has a contour corresponding to a segment of a sphere.

107. The solid state light fixture of claim 106, wherein the contour is substantially hemispherical.

108. The solid state light fixture of claim 104, wherein the dome is configured such that the portion of the reflective interior surface of the optical integrating cavity formed by the dome has a contour corresponding to a segment of a cylinder.

109. The solid state light fixture of claim 108, wherein the contour is substantially semi-cylindrical.

110. The solid state light fixture of claim 104, wherein the dome and plate are configured such that the interior surface of the optical integrating cavity has a substantially rectangular cross-section.

111. The solid state light fixture of claim 83, wherein each of the solid state light emitting elements comprises a light emitting diode.

112. The solid state light fixture of claim 83, wherein:
a first one of the solid state light emitting elements is for emitting light of a spectral characteristic and is controlled to be initially active; and
a second one of the solid state light emitting elements is for emitting light of said spectral characteristic and is controlled to be initially inactive and to be activated when needed.

113. A solid state light fixture, comprising:
a plurality of solid state light emitting elements, each solid state light emitting element for emitting a point source output of light; and
means for converting the point source outputs of light from the solid state light emitting elements to a combined virtual source for output from the solid state light fixture,
wherein area of the virtual source is larger than combined area of outputs of light from the solid state light emitting elements.

114. The solid state light fixture of claim 113, wherein the means for converting produces a substantially uniform light output distribution across the area of the virtual source.

115. The solid state light fixture of claim 114, wherein the distribution is substantially Lambertian.

116. The solid state light fixture of claim 114, wherein the distribution is unpixelated.

117. The solid state light fixture of claim 114, wherein the distribution exhibits a maximum-to-minimum ratio of 2:1 or less across the area of the virtual source.

118. The solid state light fixture of claim 113, wherein:
a first one of the solid state light emitting elements is for emitting visible light of a first color; and
a second one of the solid state light emitting elements is for emitting visible light of a second color different from the first color.

119. The solid state light fixture of claim 118, wherein:
the first one of the solid state light emitting elements is for emitting visible white light; and
the second one of the solid state light emitting elements is for emitting a specific color of visible light; and
combination of the white light and the specific color light by the converting means changes color temperature of the white light before emission at the virtual source.

120. The solid state light fixture of claim 118, wherein:
the first one of the solid state light emitting elements is for emitting visible white light of a first color temperature; and
the second one of the solid state light emitting elements is for emitting visible white light of a second color temperature different from the first color temperatures.

121. The solid state light fixture of claim 118, further comprising a third one of the solid state light emitting elements for emitting visible light of a third color different from the first and second colors.

122. The solid state light fixture of claim 121, wherein the first, second and third solid state light emitting elements emit three different primary colors of visible light.

123. The solid state light fixture of claim 113, wherein the solid state light emitting elements are for emitting visible white light of substantially the same color temperature.

124. The solid state light fixture of claim 113, wherein:
a first one of the solid state light emitting elements is for emitting visible light; and
a second one of the solid state light emitting elements is for emitting ultraviolet (UV) or infrared (IR) light.

125. The solid state light fixture of claim 113, wherein said means for converting comprises:
an optical integrating cavity having a reflective interior surface, at least a portion of which exhibits a diffuse reflectivity, the optical integrating cavity being coupled for receiving the light from the solid state light emitting elements for diffuse reflection and combination within the optical integrating cavity; and
an optical aperture for allowing emission of combined light from within the interior of the optical integrating cavity.

126. The solid state light fixture of claim 125, wherein the diffuse reflection and combination within the optical integrating cavity produces the virtual source at the optical aperture.

127. The solid state light fixture of claim 126, wherein:
back of the solid state light emitting elements is coupled to emit light into the optical integrating cavity from a location on a wall of the optical integrating cavity; and
the locations on the wall of the optical integrating cavity cause substantially all light emissions from the solid state light emitting elements to reflect at least once within the optical integrating cavity before emission via the virtual source produced at the optical aperture.

128. The solid state light fixture of claim 127, wherein the diffuse reflection and combination within the optical integrating cavity produces a substantially uniform intensity distribution across an area of the optical aperture.

129. The solid state light fixture of claim 128, wherein the intensity distribution is substantially Lambertian.

130. The solid state light fixture of claim 128, wherein the intensity distribution is unpixelated.

131. The solid state light fixture of claim 128, wherein the intensity distribution exhibits a maximum-to-minimum ratio of 2:1 or less.

132. The solid state light fixture of claim 125, wherein the optical integrating cavity comprises:
a dome having a reflective surface; and
a plate having a substantially reflective surface facing the reflective surface of the dome, coupled to the dome so as to form the optical integrating cavity between the reflective surfaces of the dome and plate,
at least a portion of one of the reflective surfaces of the dome and plate being diffusely reflective.

133. The solid state light fixture of claim 132, wherein the optical aperture comprises a transmissive passage through the plate.

134. The solid state light fixture of claim 132, wherein the dome is configured such that the portion of the reflective interior surface of the optical integrating cavity formed by the dome has a contour corresponding to a segment of a sphere.

135. The solid state light fixture of claim 134, wherein the contour is substantially hemispherical.

136. The solid state light fixture of claim 132, wherein the dome is configured such that the portion of the reflective interior surface of the optical integrating cavity formed by the dome has a contour corresponding to a segment of a cylinder.

137. The solid state light fixture of claim 136, wherein the contour is substantially semi-cylindrical.

138. The solid state light fixture of claim 132, wherein the dome and plate are configured such that the optical integrating cavity has a substantially rectangular cross-section.

139. The solid state light fixture of claim 113, wherein each of the solid state light emitting elements comprises a light emitting diode.

140. The solid state light fixture of claim 113, wherein:
a first one of the solid state light emitting elements is for emitting light of a spectral characteristic and is controlled to be initially active; and
a second one of the solid state light emitting elements is for emitting light of said spectral characteristic and is controlled to be initially inactive and to be activated when needed.

141. A solid state light source having a plurality of solid state light emitting elements, the source being configured to produce a substantially uniform output of light, from point sources of light generated by the solid state elements, at a virtual source output.

142. A method of generating light from a virtual source, the method comprising:
operating a plurality of solid state light emitting elements to generate respective point sources of light; and
converting the light generated by the solid state light emitting elements to a combined virtual source of light of humanly visible having an area substantially larger than point source areas of the light generated by the solid state light emitting elements.

143. The method of claim 142, wherein distribution of light from the virtual source is substantially uniform across the area of the virtual source.

144. The method of claim 143, wherein the distribution of light from the virtual source is substantially Lambertian.

145. The method of claim 144 wherein the distribution of light from the virtual source is unpixelated.

146. The method of claim 144, wherein the distribution of light from the virtual source exhibits a maximum-to-minimum ratio of 2:1 or less.

147. A lighting system, comprising:
a plurality of solid state light emitting elements, for emitting visible light;
a diffuse optical processing element coupled to the solid state light emitting elements, for converting point sources of the visible light from the solid state light emitting elements to a virtual source of visible light; and
a controller responsive to a user input for controlling amounts of visible light supplied to the optical processing element by the solid state light emitting elements to control a characteristic of light emitted from the virtual source.

148. The lighting system of claim 147, wherein the optical processing element produces a substantially uniform distribution of the light output across an area of the virtual source.

149. The lighting system of claim 148, wherein the distribution is substantially Lambertian.

150. The lighting system of claim 148, wherein the distribution is unpixelated.

151. The lighting system of claim 148, wherein the distribution of light across the area of the virtual source exhibits a maximum-to-minimum ratio of 2:1 or less.

152. The lighting system of claim 147, wherein each of the solid state light emitting elements comprises a light emitting diode.

153. The lighting system of claim 147, wherein the plurality of solid state light emitting elements comprises at least one white solid state light emitting element.

154. The lighting system of claim 153, wherein:
the plurality of solid state light emitting elements further comprises at least one solid state light emitting element for emitting a specific color of visible light; and
the optical processing element combines the white light and the specific color light during the conversion to change color temperature of the white light before emission of converted light from the virtual source.

155. The lighting system of claim 147, wherein the plurality of solid state light emitting elements comprises a plurality of white solid state light emitting elements.

156. The lighting system of claim 155, wherein the plurality of white solid state light emitting elements comprises:
a first white solid state light emitting element for emission of white light of a first color temperature; and
a second white solid state light emitting element for emission of white light of a second color temperature different from the first temperature.

157. The lighting system of claim 156, wherein:
a first one of the white solid state light emitting elements is controlled by the controller to be initially active;
a second one of the white solid state light emitting elements is controlled by the controller to be initially inactive; and
the controller is configured for activating the initially inactive second white solid state light emitting element when needed.

158. The lighting system of claim 157, further comprising a sensor for detecting a characteristic of light from the optical processing element and providing a feedback control signal to the controller.

159. The lighting system of claim 147, wherein the controller is responsive to the sensor for activating the initially inactive second white solid state light emitting element in response to a change in the detected characteristic of the reflected light indicative of decreased performance of the first white solid state light emitting element.

160. The lighting system of claim 147, wherein the plurality solid state light emitting elements comprises:
a first solid state light emitting element for emission of visible light of a first spectral characteristic; and
a second solid state light emitting element for emission of visible light of a second spectral characteristic different from the first spectral characteristic.

161. The lighting system of claim 156, wherein:
the first solid state light emitting element is for emission of light of a first wavelength; and
the second solid state light emitting element is for, emission of light of a second wavelength different from the first wavelength.

162. The lighting system of claim 147, wherein the plurality of solid state light emitting elements comprises:
a first solid state light emitting element for emission of visible light; and
a second solid state light emitting element for emission of light of a spectral characteristic, at least a portion of the spectral characteristic of the light emitted by the second solid state light emitting element being outside the visible portion of the electromagnetic spectrum.

163. The lighting system of claim 162, wherein the second solid state light emitting element is an ultraviolet (UV) solid state light emitting element.

164. The lighting system of claim 162, wherein the second solid state light emitting element is an infrared (IR) solid state light emitting element.

165. The lighting system of claim 147, wherein the optical processing element comprises an optical integrating cavity having a reflective interior surface, at least a portion of which exhibits a diffuse reflectivity, and having an optical aperture for allowing emission of reflected light from within the interior of the optical integrating cavity into a region to facilitate a humanly perceptible lighting application for the system.

166. The lighting system of claim 165, wherein distribution of light emitted through the optical aperture is substantially uniform.

167. The lighting system of claim 166, wherein the distribution of light emitted through the optical aperture is substantially Lambertian.

168. The lighting system of claim 166, wherein the light emitted through the optical aperture is unpixelated.

169. The lighting system of claim 166, wherein the distribution exhibits a maximum-to-minimum ratio of 2:1 or less across the optical aperture.

170. The lighting system of claim 165, wherein the optical integrating cavity comprises:
a dome having a reflective surface; and
a plate having a substantially flat reflective surface facing the reflective surface of the dome, coupled to the dome so as to form the optical integrating cavity between the reflective surfaces of the dome and plate, at least a portion of one of the reflective surfaces of the dome and plate being diffusely reflective.

171. The lighting system of claim 170, wherein the optical aperture comprises a transmissive passage through the plate.

172. The lighting system of claim 170, wherein the dome is configured such that the portion of the reflective interior surface of the optical integrating cavity formed by the dome has a contour corresponding to a segment of a sphere.

173. The lighting system of claim 172, wherein the contour is substantially hemispherical.

174. The lighting system of claim 170, wherein the dome is configured such that the portion of the reflective interior surface of the optical integrating cavity formed by the dome has a contour corresponding to a segment of a cylinder.

175. The lighting system of claim 174, wherein the contour is substantially semi-cylindrical.

176. The lighting system of claim 170, wherein the dome and plate are configured such that the interior surface of the optical integrating cavity has a substantially rectangular cross-section.
